(19) United States
(12) Patent Application Publication
(10) Pub. No.: US 2026/0099563 A1
(43) Pub. Date: Apr. 9, 2026

(54) Content Inventory Management User Interface

(71) Applicant: Taboola.com Ltd., Ramat Gan (IL)

(72) Inventors: Elad Gov-Ari, Holon (IL); Kurt Gessler, Yorkville, IL (US); Ohad Levy, Meitar (IL); Udaya Manchikatla, La Crescenta, CA (US); Isaiah Yoo, Los Angeles, CA (US)

(21) Appl. No.: 19/350,034

(22) Filed: Oct. 5, 2025

Related U.S. Application Data
(60) Provisional application No. 63/704,617, filed on Oct. 8, 2024.

(51) Int. Cl. G06F 16/958; G06F 3/04817; G06F 16/9535

(52) U.S. Cl. CPC G06F 16/958; G06F 3/04817; G06F 16/9535

(57) ABSTRACT

A method comprising: displaying in a user interface a plurality of records representative of content items publishable on a webpage, wherein each record comprises data descriptive of a corresponding content item; designating, by a processor, a content item as unpublishable, wherein the user interface is updated to reflect the unpublishable designation; and preventing publishing of the content item due to the unpublishable designation. The designating may be performed automatically without user intervention, or based on user input that manually designates the content item as unpublishable. The user interface may display information including title, publication time, digital media, category, and expiration time for each content item, along with interactive unpublish and protect icons enabling toggling of published and protected states.

### CROSS-REFERENCE TO RELATED APPLICATIONS

This application claims the benefit of U.S. Provisional Application No. 63/704,617, filed on Oct. 8, 2024, the entire contents of which are hereby incorporated by reference for all purposes and without giving rise to disvowment.

### TECHNICAL FIELD

The present disclosure relates to content management systems and content inventory management, and to systems and methods for dynamic content inventory management, in particular.

### BACKGROUND

Content management systems (CMS) serve as foundational platforms for organizing, storing, and delivering digital content across websites and applications. These systems typically maintain content inventories that catalog various information assets including web pages, multimedia files, documents, and associated metadata.

Content recommendation systems, such as provided by TABOOLA® and other providers, work alongside CMS platforms to analyze user behavior and preferences, delivering personalized content experiences by selecting and presenting relevant items from available inventories.

### BRIEF SUMMARY

One exemplary embodiment of the disclosed subject matter is a method comprising: displaying in a user interface a plurality of records representative of a plurality of content items that are publishable on a webpage, wherein each of the plurality of records comprising data descriptive of a corresponding content item; designating, by a processor, a content item of the plurality of content items as unpublishable, wherein the user interface is updated to reflect the content item being designated as unpublishable; and preventing from publishing on the webpage the content item due to the unpublishable designation.

Optionally, the webpage is published using a Content Management System (CMS) having a content inventory, wherein a content recommendation system comprises a Content Management System (CMS)-agnostic content inventory, wherein the content recommendation system is configured to serve content recommendations based on the CMS-agnostic content inventory, wherein the user interface is a user interface of the content recommendation system, wherein the user interface is configured to assist an administrator of the webpage in curating potential content recommendations to users visiting the webpage.

Optionally, said designating is performed automatically and without user intervention.

Optionally, a specific content item that is designated as protected cannot be designated automatically as unpublishable.

Optionally, said designating is performed at an expiration time of the content item, wherein the expiration time is displayed visually in the user interface.

Optionally, the user interface is updated to reflect the content item being designated as unpublishable further comprises: enabling the user interface to display an automatically generated reason for designating the content item as unpublishable.

Optionally, said designating is based on a user input that manually designates the content item as unpublishable.

Optionally, the user interface comprises a display that includes for each displayed record representative of a specific content item at least the following information: a title of the specific content item; a publication time of the specific content item; a digital media of the specific content item; a category of the specific content item; and an expiration time of the specific content item.

Optionally, the display further includes for each displayed record representative of a specific content item at least an unpublish icon and a protect icon, wherein the unpublish icon visually indicates whether the specific content item is unpublishable, wherein the unpublish icon is interactive and enables toggling of a published state of the specific content item, wherein the protect icon visually indicates whether the specific content item is protected from being designated as unpublishable, wherein the protect icon is interactive and enables toggling of a protected state of the specific content item.

Optionally, the category of a first content item out of the plurality of content items is automatically generated based on information associated with the first content item.

Optionally, the user interface enables manual editing of the expiration time of the specific content item.

Optionally, user interaction with the user interface causes a record representative of a content item to be flagged, wherein the user interface displays the flagged status when displaying the record representative of a content item.

Another exemplary embodiment of the disclosed subject matter is a system comprising: a processor; and a memory coupled to the processor and storing instructions that, when executed by the processor, cause the system to: display in a user interface a plurality of records representative of a plurality of content items that are publishable on a webpage, wherein each of the plurality of records comprising data descriptive of a corresponding content item; designate a content item of the plurality of content items as unpublishable, wherein the user interface is updated to reflect the content item being designated as unpublishable; and prevent from publishing on the webpage the content item due to the unpublishable designation.

Optionally, the system further comprises a Content Management System (CMS) and a content recommendation system, said CMS having a content inventory, said content recommendation system comprising a Content Management System (CMS)-agnostic content inventory, wherein the webpage is published using said CMS, wherein said content recommendation system is configured to serve content recommendations based on said CMS-agnostic content inventory, wherein the user interface is a user interface of said content recommendation system, wherein the user interface is configured to assist an administrator of the webpage in curating potential content recommendations to users visiting the webpage.

Optionally, said designating is performed automatically and without user intervention.

Optionally, a specific content item that is designated as protected cannot be designated automatically as unpublishable.

Optionally, said designating is performed at an expiration time of the content item, wherein the expiration time is displayed visually in the user interface.

Optionally, the user interface is updated to reflect the content item being designated as unpublishable further comprises: enabling the user interface to display an automatically generated reason for designating the content item as unpublishable.

Optionally, said designating is based on a user input that manually designates the content item as unpublishable.

Optionally, the user interface comprises a display that includes for each displayed record representative of a specific content item at least the following information: a title of the specific content item; a publication time of the specific content item; a digital media of the specific content item; a category of the specific content item; and an expiration time of the specific content item; wherein the display further includes for each displayed record representative of a specific content item at least an unpublish icon and a protect icon, wherein the unpublish icon visually indicates whether the specific content item is unpublishable, wherein the unpublish icon is interactive and enables toggling of a published state of the specific content item, wherein the protect icon visually indicates whether the specific content item is protected from being designated as unpublishable, wherein the protect icon is interactive and enables toggling of a protected state of the specific content item.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide embodiments or aspects of the disclosure and do not limit the scope or the disclosure. In the drawings:

FIG. 1 shows a flowchart of a method for managing content items with expiration-based unpublishing, in accordance with some embodiments of the disclosed subject matter;

FIG. 2A shows a flowchart of a process for managing content items using machine learning for freshness prediction, in accordance with some embodiments of the disclosed subject matter;

FIG. 2B shows a flowchart of a process for managing content items based on newer content publication, in accordance with some embodiments of the disclosed subject matter;

FIG. 3 shows a flowchart of a process for managing content inventory between system components, in accordance with some embodiments of the disclosed subject matter;

FIG. 4 shows a sequence diagram illustrating interactions between a Client Device, Content Management System, Recommendation System, and Content Inventory, in accordance with some embodiments of the disclosed subject matter;

FIG. 5 shows a flowchart of a process for updating a CMS-agnostic content inventory, in accordance with some embodiments of the disclosed subject matter;

FIG. 6A shows a flowchart for updating a CMS-agnostic content inventory with historic content verification, in accordance with some embodiments of the disclosed subject matter;

FIG. 6B shows a flowchart for updating a CMS-agnostic content inventory with content history management, in accordance with some embodiments of the disclosed subject matter;

FIG. 7 shows a flowchart of a process for managing unpublishable content through a user interface, in accordance with some embodiments of the disclosed subject matter;

FIG. 8 shows a flowchart of a process for managing protected content through a user interface, in accordance with some embodiments of the disclosed subject matter;

FIG. 9 shows a block diagram of a content management system with interconnected components, in accordance with some embodiments of the disclosed subject matter;

FIG. 10A shows a content inventory management interface with performance metrics and filtering capabilities, in accordance with some embodiments of the disclosed subject matter;

FIG. 10B shows a content inventory management interface with category-based filtering options, in accordance with some embodiments of the disclosed subject matter;

FIG. 10C shows a content inventory management interface with interactive widgets for content management, in accordance with some embodiments of the disclosed subject matter; and

FIG. 10D shows a content inventory management interface displaying tools for managing content items requiring additional actions, in accordance with some embodiments of the disclosed subject matter.

### DETAILED DESCRIPTION

One technical problem dealt with by the disclosed subject matter is the identification of outdated content in content management systems. Content can quickly become outdated even in the absence of explicit updates, impacting user engagement and satisfaction. Naïve content management approaches may rely on predetermined expiration timeframes or modification timestamps that may not accurately reflect when content becomes irrelevant. For example, content with time-sensitive keywords such as “tonight's game” or “current stock price” may become outdated much faster than formal expiration dates would suggest, while rollout definitions of relevant timeframes per category may not capture the dynamic nature of content relevance.

In some embodiments, the disclosed subject matter provides automatic identification of outdated content based on features of content items. In some embodiments, an effective expiration time of a content element may be predicted based on features of content items, such as keywords, the content of the content item (e.g., the text of an article), formal expiration times, publication times, or the like. In some embodiments, time-related keywords in titles or subtitles, such as “tonight”, “today”, “Saturday”, or the like, may be indicative of expiration time of content items. The expiration time may be based on the current time, the time of publication (e.g., indicating when “tonight” occurs, when “today” ends, or which “Saturday” is referred to), or the like. Similarly, the content of the content item itself may indicate when the content expires.

In some embodiments, the effective expiration time may be predicted based on freshness prediction using machine learning algorithms trained on historical content data and labeled expiration times. Additionally, or alternatively, content may be determined to be outdated based on identification of newer items related thereto, such as follow-up articles or publications with newer publication times that render previous content less relevant.

Another technical problem dealt with by the disclosed subject matter is the efficient detection of updated content without relying solely on metadata. Content may be updated without changing modification times or other metadata, making it challenging to identify changes using naïve approaches. Updates may be made to enhance or refine existing content rather than replace it entirely, requiring a nuanced understanding of content context. In some cases, due to caching and use of proxy servers, old content may be served at a later date, and hence simple timestamp comparisons may be insufficient to identify which version is the most up-to-date version. The naïve solution of blind crawling of content to detect updates is resource-intensive and may not capture real-time changes effectively.

In some embodiments, the disclosed subject matter provides a system that triggers content update checks in response to user interactions, avoiding unnecessary blind crawling. In some embodiments, when a user reaches a webpage, a query for comparing the page with the latest version stored by the CMS may be issued to determine whether the page should be updated. In some embodiments, identifiers such as URL-based identifiers and content properties may be utilized to determine if an update is necessary, considering factors beyond the CMS's “modify date” property. In some embodiments, the system may perform comparison with respective stored versions according to the identifier and based on provided properties to decide if content needs to be updated. In some embodiments, the update check is performed with respect to all previous versions of the content item to ensure that properties are new and different from any previously seen version.

Another technical problem dealt with by the disclosed subject matter is maintaining accurate content inventory across distributed systems with different CMS platforms. Content recommendation systems often need to work with multiple content management systems that may have different data structures, update mechanisms, and content organization approaches. Maintaining a unified view of content across these heterogeneous systems while ensuring data consistency and avoiding duplication presents significant technical challenges.

In some embodiments, the disclosed subject matter provides a CMS-agnostic content inventory that can work across different platforms. In some embodiments, the system may obtain content items from client devices that include location identifiers and properties, where each property provides descriptive information regarding the content item. In some embodiments, the system may retrieve pre-existing content items from the CMS-agnostic content inventory and compare properties to determine if updates are necessary. In some embodiments, the system may update pre-existing content items based on differences in properties while maintaining a history of previous versions to prevent old versions from being reintroduced to the inventory.

In some embodiments, the disclosed subject matter may extend the CMS-agnostic content inventory disclosed in U.S. patent application Ser. No. 19/222,646, entitled “WEBPAGE PERSONALIZATION”, filed May 29, 2025, which is hereby incorporated by reference in its entirety without giving rise to disvowment.

Another technical problem dealt with by the disclosed subject matter is providing effective user interfaces for content curation and management. Content managers need tools that allow them to efficiently review, organize, and make decisions about large volumes of content items. Traditional content management interfaces may not provide sufficient visibility into content performance metrics, expiration status, or automated decision-making processes, making it difficult for users to effectively curate content inventories.

In some embodiments, the disclosed subject matter provides a user interface that showcases potential content inventory and provides tools for content curation. In some embodiments, the user interface may display available content items along with relevant information such as publication times, topics, user engagement metrics, expiration times, and performance data. In some embodiments, the user interface may enable automatic or semi-automatic unpublishing of content items that are deemed outdated, unsuitable or irrelevant, with options to provide explanations for unpublishing decisions.

As referred to herein, the term “unpublished” refers to the exclusion of content items from active content distribution channels, recommendation systems, and content discovery mechanisms while potentially maintaining the accessibility of the underlying linked content through direct access methods. An unpublished content item is removed from content inventories, content recommendation algorithms, homepage listings, category sections, search results, personalized content feeds, and automated content serving systems operated by a CMS, Content Recommendation System, or other content management entities. For example, when a content item representing a news article is unpublished, the content item preview comprising the article title, subtitle, author name, publication date, thumbnail image, and link to the full article would no longer appear in homepage content listings, “recommended for you” sections, “related articles” widgets, category-based content directories, or search result displays. However, the underlying webpage containing the full article text may remain accessible to users who navigate directly to the article URL through bookmarks, external links, or manual entry into their browser. The unpublishing process ensures that content items are prevented from being served through content distribution mechanisms while maintaining the technical accessibility of the underlying content through direct access pathways, thereby providing granular control over content visibility and discovery without necessarily removing the content entirely from web servers or content repositories.

In some embodiments, the interface tools may include interactive widgets that implement management tools. For example, an unpublish widget may allow preventing from serving selected content, and a flag widget that allows users to manage content items individually or through batch operations.

Another technical problem dealt with by the disclosed subject matter is preventing the inadvertent removal of important content through automated processes. While automated content management can improve efficiency, it may sometimes incorrectly identify valuable content as outdated or irrelevant. Content managers need mechanisms to protect certain content items from automated removal while still benefiting from automated content curation for the majority of their inventory.

In some embodiments, the disclosed subject matter provides protection mechanisms for content items that should not be automatically unpublished. In some embodiments, content items may be designated as “protected” to prevent them from being automatically designated as “unpublished”. In some embodiments, the user interface may include protect widgets that allow users to manually protect specific content items from being unpublished either automatically or manually. In some embodiments, the system may reject attempts to automatically designate protected content items as unpublished while still allowing manual override when necessary.

Another technical problem dealt with by the disclosed subject matter is accurately predicting content freshness and relevance over time. Different types of content have varying lifespans and relevance patterns that may not be captured by simple time-based rules. News articles, sports scores, and breaking news may become outdated within hours, or as the relevant live event progresses, while evergreen content such as how-to guides may remain relevant for weeks, months or even years.

In some embodiments, the disclosed subject matter provides machine learning-based freshness prediction that considers content context and historical patterns. In some embodiments, machine learning prediction tools may be trained with respect to content of historic content items and labeled expiration times for each historic content item, thereby enabling the prediction of expiration times for new content items based on their content. In some embodiments, the system may analyze content features such as titles, content of the content items, keywords, categories, user engagement metrics, and topic trends to predict effective expiration times. In some embodiments, the prediction may be updated in response to identification of new items that may render existing content outdated, such as follow-up articles or newer publications on the same subject matter.

Another technical problem dealt with by the disclosed subject matter is managing content updates for dynamic content that changes frequently within short timeframes. Content such as live sport events coverage and breaking news updates (e.g., covering live news events) may change within minutes, requiring rapid detection and updating mechanisms. Periodic update checks may not be sufficient for such dynamic content, leading to users being presented with outdated information. Alternatively, if the periodic updates are performed in short intervals, extensive computational power is wasted as many, if not most, of the articles are not updated so frequently and therefore need not be frequently checked for updates.

In some embodiments, the disclosed subject matter provides real-time content update detection based on user interactions and content analysis. In some embodiments, the system may trigger content update checks when users encounter content items (e.g., access a webpage where the content item, not the underlying linked article, is being displayed) or when they access the underlying content itself (e.g., linked article), ensuring that the most current information is available when needed. In some embodiments, the system may analyze content properties and compare them with stored versions to determine if updates are necessary, considering factors beyond “modification time” properties. In some embodiments, content may be updated directly based on new data or through crawling of URLs that is triggered when differences are detected.

One technical effect obtained by the disclosed subject matter is improving content relevancy and freshness by automatically identifying outdated content items based on contextual analysis rather than relying solely on predetermined expiration timeframes. The system analyzes content features to predict effective expiration times, thereby ensuring users are presented with current and relevant information while reducing the presentation of stale content that may negatively impact user experience.

Another technical effect obtained by the disclosed subject matter is reducing computational overhead and reducing network traffic by triggering content update checks only in response to user interactions rather than performing continuous or periodic crawling of all content. This approach minimizes unnecessary server load and bandwidth consumption while ensuring that content updates are detected when they are most needed, thereby improving system efficiency and response times.

Yet another technical effect obtained by the disclosed subject matter is enabling cross-platform content management through a CMS-agnostic content inventory that can work with multiple heterogeneous content management systems. The system maintains consistency across different platforms by using location identifiers and content properties to track and update content items, while preventing duplication and maintaining historical versions, thereby providing a unified view of content across distributed systems. The CMS-agnostic content inventory further reduces CMS-dependency and integration challenges, as the disclosed subject matter is agnostic to the CMS and does not rely on a specific API or the CMS provider's willingness to cooperate with the disclosed subject matter.

Yet another technical effect obtained by the disclosed subject matter is preventing the inadvertent removal of valuable content through protection mechanisms that allow content items to be designated as protected from automated unpublishing processes. This selective protection capability enables organizations to benefit from automated content curation while ensuring that critical or evergreen content remains available, thereby balancing automation efficiency with content preservation requirements.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

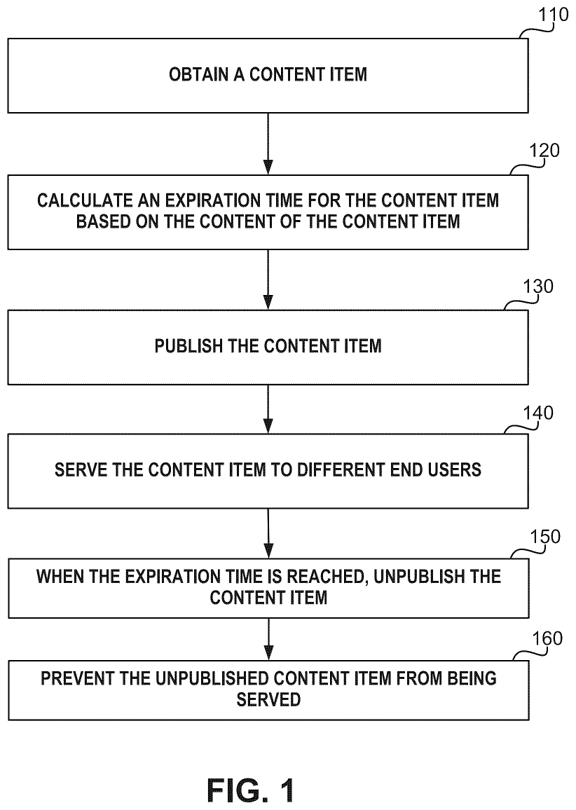

Referring now to FIG. 1, the disclosed subject matter provides a method for managing content items through automated expiration and unpublishing processes. The method may implement a sequential workflow that begins with content acquisition and progresses through expiration time calculation, publication, serving, and automated unpublishing based on content-specific characteristics. The method may address the technical challenges of maintaining fresh and relevant content by implementing expiration mechanisms that consider content features rather than relying solely on predetermined timeframes. It is noted that the method may be implemented by a CMS, by a Content Recommendation System, or by other content-publishing systems.

On Step 110, the method may obtain a content item to be published on a webpage. The content item may comprise a link to an item. The content item may comprise content to be displayed to a user viewing the webpage and offering the user to view the linked item. Step 110 may involve receiving content items from various sources, such as CMSs, editorial workflows, or automated content generation processes. The content item may include textual content, multimedia elements, metadata, and other descriptive information that characterizes the nature and subject matter of the linked item.

It is noted that the content item may not necessarily include all the content of the underlying linked item itself. Consider a news website, such as CNN™, BBC™, NEW YORK TIMES™, or the like. In such as website, a content item may be a descriptor of an article, but it may not necessarily include the entire text of the article, all media files shown in the article, and the like. Instead, the content item may represent an abbreviated “preview” version that is displayed to a user in a different page and which the user can click on to read the article itself. For example, in a sports section of the news website, “preview” versions of all currently available articles may be shown. The “preview” version may therefore include some content of the article, but not all of it. For example, it may include the title, the main media file, the subtitle, a prefix of the text, a name of the author, the publication time, and other similar properties. The “preview” version may also include a link to the page in which the article itself is displayed.

In some embodiments, the content item being obtained on Step 110 is encountered by the system for the first time. The content item may be encountered by the system based on crowd-sourced-based crawling, bling crawling and scraping, through the use of an API (e.g., published by a CMS and announced as such to the system via an appropriate API), or the like.

On Step 120, an expiration time for the content item may be calculated. The calculation may be performed based on the content of the content item. Step 120 may implement analysis of content characteristics to determine when the content item may become outdated or less relevant to users. The calculation process may examine various features of the content item, including textual content, keywords, subject matter, publication context, and other factors that may influence the longevity and relevance of the content. In some embodiments, based on a category of the content item, an initial expiration time may be defined. The content-based calculation may override the initial expiration time and shorten the initial expiration time when content analysis indicates faster obsolescence. In some embodiments, the content-based calculation may not override the initial expiration time when the calculation yields a longer expiration time and would extend beyond the initial expiration time.

Following the expiration time calculation, the method may advance to Step 130 where the content item may be published and made available for serving to users. Step 130 may involve integrating the content item into the publication workflow and making the content item accessible through a CMS, a Content Recommendation System, or the like. The publication process may include updating content inventories, indexing the content item for search and discovery, and configuring the content item for delivery to end users through various channels and platforms.

On Step 140, the method may serve the content item to different end users through various distribution mechanisms. Step 140 may involve a CMS of the webpage that may be configured to serve published content items to users viewing the webpage. In some embodiments, Step 140 may involve a Content Recommendation System that may be configured to serve published content items to users viewing the webpage. The Content Recommendation System may be configured to serve content that is recommended to the user. Additionally, or alternatively, the Content Recommendation System may be configured to personalize the webpage to a specific user by replacing content items displayed in the webpage with other content items. The serving process may consider user preferences, browsing history, demographic information, and other factors to determine which content items may be most relevant to individual users. In some embodiments, Step 140 may be repeated for several different users, using different client devices, and requesting content to be viewed at different times.

The method may continue serving the content item until reaching Step 150. On Step 150, in response to reaching the calculated expiration time, the content item may be unpublished. Step 150 may implement automated unpublishing mechanisms that remove the content item from active serving when the calculated expiration time has been reached. The unpublishing process may involve updating CMSs to mark the content item as expired, removing the content item from recommendation algorithms, preventing further distribution of the content item to users by a Content Delivery Network (CDN), or the like. In some embodiments, Step 150 may comprise causing the relevant system (e.g., CMS, Content Recommendation System, CDN, or the like) to avoid serving the content item to users viewing the webpage. As a result, on Step 160, the unpublished content item is prevented from being served to users. The unpublishing mechanisms may include updating content inventories, modifying recommendation algorithms, and implementing checks within content serving systems to filter out unpublished content items. In some embodiments, Step 160 may involve maintaining records of unpublished content items to prevent their reintroduction into active serving systems and to support audit trails for content management decisions.

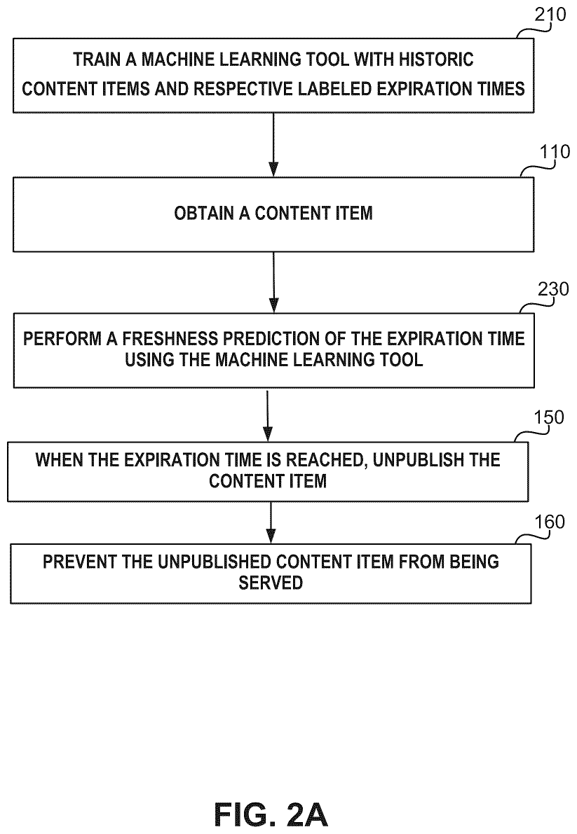

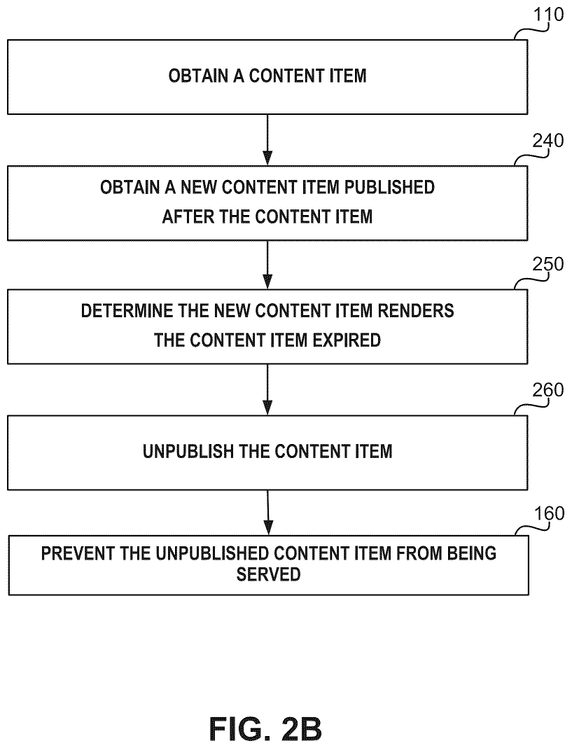

Referring now to FIG. 2A, the disclosed subject matter provides a machine learning-based approach for predicting content freshness and expiration times based on analysis of historic content patterns and labeled training data. The method may implement artificial intelligence algorithms to analyze content features, text, images, and metadata for pattern recognition and context understanding that extends beyond simple rule-based approaches. The machine learning prediction tool may implement a supervised machine learning model that is trained using training datasets that include content of historic content items and labeled expiration times for each historic content item, thereby enabling the prediction tool to learn complex relationships between content item characteristics and actual content lifecycle patterns.

Step 210 may involve training a machine learning tool with historic content items and their respective labeled expiration times to establish baseline patterns for content freshness prediction. Step 210 may include analyses of diverse content features including textual content, multimedia elements, metadata tags, publication contexts, and user engagement patterns from historical data. The training process may incorporate supervised learning techniques where the machine learning prediction tool learns to associate specific content characteristics with observed expiration patterns from past content items. In some embodiments, Step 210 may involve processing large volumes of historic content data to identify correlations between content features such as keywords, categories, publication timing and actual content lifecycle durations that were observed in practice.

The machine learning prediction tool may generate dynamic summaries of the content linked by the content items using artificial intelligence (AI) techniques, such as topic summarization and Large Language Models (LLMs) to quickly assess relevance and timeliness without requiring manual review of each content item. The prediction tool may analyze textual content to identify time-sensitive keywords, subject matter indicators, and contextual clues that suggest content longevity patterns. In some embodiments, the machine learning tool may perform artificial intelligence-powered sentiment analysis by analyzing user comments, social media reactions, and various engagement forms to gauge public interest levels and adjust expiration date predictions accordingly. The sentiment analysis capabilities may enable the system to detect shifts in user interest or engagement that may indicate when content may become less relevant to audiences.

Following the training phase, the method may proceed to a Step 110 where a content item may be obtained for processing through the trained machine learning prediction system. Step 110 may involve receiving new content items that have not been previously analyzed by the machine learning prediction tool, along with associated metadata, content properties, and contextual information that may be relevant for freshness prediction. The content acquisition process may include pre-processing steps to extract relevant features from the content item that correspond to the types of features that were used during the training phase in Step 210.

A Step 230 may implement the freshness prediction process using the trained machine learning tool to calculate expiration times based on content analysis. Step 230 may involve performing a freshness prediction of the expiration time based on the content of the content item, wherein the freshness prediction may be performed using the machine learning prediction tool that was trained in Step 210. The prediction process may analyze time-related keywords appearing in titles of content items, such as temporal references, event-specific language, or time-sensitive terminology that may indicate shorter or longer content lifespans. In some embodiments, Step 230 may utilize LLMs to automatically generate comprehensive metadata tags for content items that may be more nuanced than manually assigned tags, thereby providing richer feature sets for expiration prediction algorithms.

The machine learning prediction tool may employ artificial intelligence-powered image and video analysis to assess visual elements such as clothing styles, technology depicted in images, identifiable events, specific individuals or groups of individuals, weather phenomenon, seasonal features, or other visual indicators that may help determine content longevity patterns. The visual analysis capabilities may complement textual analysis by identifying visual cues that suggest whether content may have lasting relevance or may become outdated quickly due to changing visual trends or technological obsolescence. In some embodiments, Step 230 may involve the machine learning tool simulating user interactions with content over time to predict how content relevance might change under various scenarios, thereby providing more accurate expiration predictions based on anticipated user behavior patterns.

The system may integrate with APIs for upcoming events or holidays to adjust expiration dates for related content based on external factors that may influence content relevance. The integration capabilities may enable the machine learning prediction tool to consider external events, seasonal patterns, or scheduled occurrences that may affect when content becomes outdated or gains renewed relevance. For example, holiday related content may lose relevance after the holiday occurs, and become again relevant leading up to the holiday in following years. In some embodiments, the prediction process may use a hybrid approach combining rule-based and probabilistic methods for expiration prediction, applying hard rules for certain content types while calculating probability of relevance for more nuanced content categories.

The machine learning system may maintain a database of average content lifespans for different categories and use this information as a baseline for expiration predictions that may be refined through machine learning analysis. The database may store statistical and other information about content performance patterns across various categories, enabling the prediction tool to establish initial expiration estimates that may be adjusted based on specific content features identified through machine learning analysis. In some embodiments, the machine learning system may assign different weights to various time-related terms, for example breaking news content may receive shorter expiration time predictions compared to annual reports or evergreen content that may have longer predicted lifespans.

When Step 150 may be reached, the content item may be unpublished based on the expiration time that was calculated through the machine learning prediction process in Step 230.

Referring now to FIG. 2B, the disclosed subject matter provides a method for determining content expiration based on the publication of newer related content items. The method may implement dynamic expiration mechanisms that consider relationships between content items rather than relying solely on predetermined time-based expiration rules. The approach may address scenarios where the publication of new content may render existing content outdated or less relevant, even when the existing content has not reached its originally calculated expiration time. The method may enable more responsive content management by detecting when newer publications make existing content items obsolete or superseded.

On Step 240, a new content item that has been published after the publication time of the original content item obtained at Step 110, may be obtained. The new content item may be obtained in a similar manner to how the original content item was obtained at Step 110.

Following the acquisition of the new content item, the method may advance to a Step 250 where a determination may be made whether the new content item renders the original content item as expired. Step 250 may implement analysis algorithms that compare the content of the new content item with the content of the original content item to assess whether the newer publication supersedes, contradicts, or otherwise diminishes the relevance of the existing content. The determination process may examine subject matter overlap, factual updates, temporal relationships, and contextual connections between the content items to evaluate whether the original content item should be considered expired due to the publication of the newer content. In some cases, keyword analysis, topic analysis, context extraction, or other methods may be employed. Additionally, or alternatively, the system may identify the relationship between different content items based on user interactions with related content items. As an example, based on users that previously viewed the article of the original content item having a high correlation with users that also view the article of the new content item.

Step 250 may analyze various factors to determine content expiration relationships, including whether the new content item may be a follow-up item to the original content item that addresses the same subject matter. The analysis may consider whether the new content item provides updated information, corrected facts, or more recent developments related to the same topic covered by the original content item. In some embodiments, Step 250 may evaluate whether the new content item represents a continuation of a developing story, an update to previously reported information, or a more comprehensive treatment of the same subject matter that may render the original content item less valuable to users.

The determination process in Step 250 may consider the temporal relationship between the content items, examining whether the new content item was published sufficiently close in time to the original content item to suggest a direct relationship or update scenario. The analysis may also evaluate the source, authorship, and publication context of both content items to determine whether they represent related coverage of the same subject matter or independent treatments of similar topics. In some embodiments, the system may analyze user engagement patterns, click-through behaviors, and content consumption metrics to determine whether users may be preferentially engaging with the newer content item over the original content item, suggesting that the newer publication may have rendered the original content less relevant.

When Step 250 determines that the new content item renders the original content item as expired, the method may proceed to a Step 260 where the original content item may be unpublished based on the relationship with the newer content. Step 260 may implement automated unpublishing mechanisms that remove the original content item from active serving based on the determination that newer related content has superseded the original publication. The unpublishing process may involve updating content management systems, recommendation algorithms, and content inventories to reflect the expired status of the original content item. The update may or may not indicate the reason for the original content item being rendered as irrelevant (i.e., due to the publication of related newer content, and potentially pointing to the specific newer item).

It is noted that various factors may be considered before the unpublishing decision, such as the degree of overlap between the content items, the comprehensiveness of the newer content, and the potential value that the original content item may still provide to users despite the publication of newer related content, or the like. In some embodiments, graduated unpublishing approaches may be implemented where the original content item may be deprioritized in recommendation algorithms or marked with indicators that newer related content may be available, rather than completely removing the original content from serving systems. The unpublishing process may also maintain records of the relationship between the original and newer content items to support content management audit trails and to enable potential restoration of the original content if circumstances change.

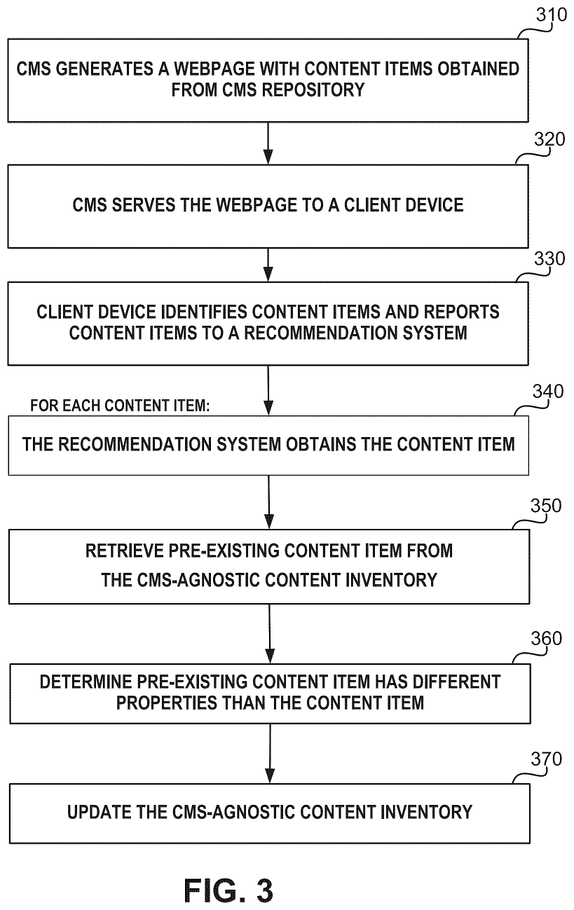

Referring now to FIG. 3, the disclosed subject matter provides a comprehensive method for managing content inventory across multiple system components while maintaining a CMS-agnostic content inventory that may operate independently of specific CMS system. The method may implement a distributed architecture where content items may be tracked, analyzed, and updated across different system components including CMSs, client devices, and Recommendation Systems. The approach may address technical challenges associated with maintaining consistent content inventories across heterogeneous systems that may have different data structures, update mechanisms, and content organization approaches. The method may enable unified content management while preserving the independence and flexibility of individual system components. Additionally, or alternatively, the method may be applicable even without the cooperation of the CMS, such as when the CMS may not have a relevant API that can be used to provide information to the system according to the disclosed subject matter.

Step 310 may involve a CMS generating a webpage with content items obtained from a CMS repository. Step 310 may implement content retrieval mechanisms that access stored content items from CMS-specific content inventories and assemble the content items into webpages for delivery to users. The content generation process may involve selecting appropriate content items based on webpage requirements, user preferences, publication schedules, editorial decisions, and the like. In some embodiments, Step 310 may involve formatting content items according to webpage templates, applying styling and layout specifications, and preparing content items for transmission to client devices. The CMS may maintain a content inventory. The content inventory of the CMS may be separate and distinct from the CMS-agnostic content inventory, thereby enabling the system to work with multiple CMS platforms while maintaining a unified view of content across different systems.

The method may proceed to an Step 320 where the CMS may serve the webpage to a client device. Step 320 may implement content delivery mechanisms that transmit the generated webpage from the CMS to client devices over network connections. The client device may be, for example, a user device having a web browser which was directed to fetch and display a page from a website that is published using the CMS. The serving process may involve establishing communication channels between the CMS and client devices, transmitting webpage content including textual elements, multimedia files, metadata, and interactive components. In some embodiments, Step 320 may involve optimizing content delivery based on client device capabilities, network conditions, or user preferences. The client device may be used by a user accessing the webpage, wherein the webpage may be served by the CMS, and the serving process may ensure that content items may be properly rendered and displayed to users through appropriate client device interfaces.

On Step 330, the client device may identify content items and report the content items to a recommendation system. Step 330 may be implemented by client-side code executed by the web browser that is being run by the client device. The received webpage may be analyzed to extract information about individual content items, including location identifiers, content properties, and descriptive information. The client device may analyze webpage structure, metadata, embedded content elements, and other characteristics to identify discrete content items that may be relevant for content inventory management. Additionally, or alternatively, the analysis may be performed based on tags in HTML code that identify potential content item locations. The tags may be defined and inserted by the CMS when generating the webpage (310) in accordance with a template or predefined instructions. In some embodiments, the content item may comprise a location identifier and one or more properties. Each of the properties may be descriptive information regarding the content item, such as title, subtitle, media, author, or the like. The location identifier may be a Uniform Resource Locator (URL) that may provide a unique reference for accessing the content item across different systems and platforms.

The content identification process in Step 330 may extract various types of content properties that may characterize the content item for inventory management purposes. The one or more properties may comprise at least one of a title of the content item, an author of the content item, or a media file of the content item. The title may provide textual identification of the content item subject matter, while the author property may indicate the creator or source of the content item. Media files may include images, videos, audio recordings, or other multimedia elements that may be associated with the content item. In some embodiments, the content properties may include additional descriptive information such as publication dates, content categories, keywords, descriptions, or other metadata that may characterize the content item for analysis and management purposes.

Step 340, Step 350, Step 360, and Step 370 may be executed for each content item identified and reported by any client device in Step 330. Each content item may be individually analyzed and processed according to the content inventory management protocols

On Step 340, the recommendation system may obtain the content item for processing. The recommendation system may receive content item information including the location identifier and associated properties, and may prepare the content item data for comparison with existing content inventory records. In some embodiments, Step 340 may involve validating the received content item information, performing data normalization or standardization processes, and preparing the content item for integration with the CMS-agnostic content inventory management system.

Step 350 may involve retrieving from the CMS-agnostic content inventory a pre-existing content item that may be characterized by comprising the location identifier of the content item. Step 350 may implement database query mechanisms that search the CMS-agnostic content inventory using the location identifier as a key to locate any existing records that may correspond to the same content item. The retrieval process may examine stored content inventory records to identify pre-existing content items that may share the same location identifier, indicating that the content item may have been previously processed and stored within the inventory system. In some embodiments, Step 350 may involve accessing distributed database systems, performing index lookups, or executing search algorithms to efficiently locate pre-existing content items within large content inventories that may contain numerous content items from multiple sources and CMS platforms.

On Step 360 a determination may be made whether the pre-existing content item may have different properties than the content item received from the client device in Step 340. The comparison process may examine various property types including titles, authors, media files, publication dates, content descriptions, and other descriptive information to determine whether the content item may have been modified subsequent to the storing in the inventory of the pre-existing version. In some embodiments, the determination may involve analyzing property values, comparing metadata fields, performing hash comparisons of content elements, executing similarity analysis algorithms, and the like, to detect changes between content item versions.

Step 360 may consider various factors when determining whether content properties may be different, such as exact matches between property values, partial differences in content elements, and contextual changes that may affect content relevance or accuracy. The comparison process may account for minor formatting differences, timestamp variations, or metadata updates that may not represent substantial content changes. In some embodiments, Step 360 may implement threshold-based comparison mechanisms that may determine whether property differences may be significant enough (e.g., a difference measurement is above a predetermined threshold) to warrant content inventory updates, thereby avoiding unnecessary processing of trivial changes while ensuring that meaningful content modifications may be properly detected and processed.

The method may conclude with a Step 370 where the CMS-agnostic content inventory may be updated based on the determination results from Step 360. Step 370 may implement content inventory update mechanisms that may modify stored content item records when differences may be detected between the newly received content item and the pre-existing content item. The update process may involve replacing outdated property values with current information, adding new properties that may not have been previously stored, and maintaining historical records of content item changes, for example for audit and analysis purposes. In some embodiments, Step 370 may comprise updating the pre-existing content item in response to a determination that the one or more properties of the content item may be different, at least partially, from corresponding one or more properties of the pre-existing content item.

Step 370 may implement update logic that may ensure content inventory accuracy while preventing the reintroduction of outdated content versions. The update process may maintain records of all previous content item versions, enabling the system to verify that newly received content properties may represent genuine updates rather than previously seen content states. In some embodiments, the update mechanisms may involve updating database records, modifying search indexes, refreshing content recommendation algorithms, and notifying other system components of content inventory changes. The CMS-agnostic nature of the inventory system may enable Step 370 to process content updates from multiple CMS platforms while maintaining consistent data structures and update protocols across different content sources and management systems.

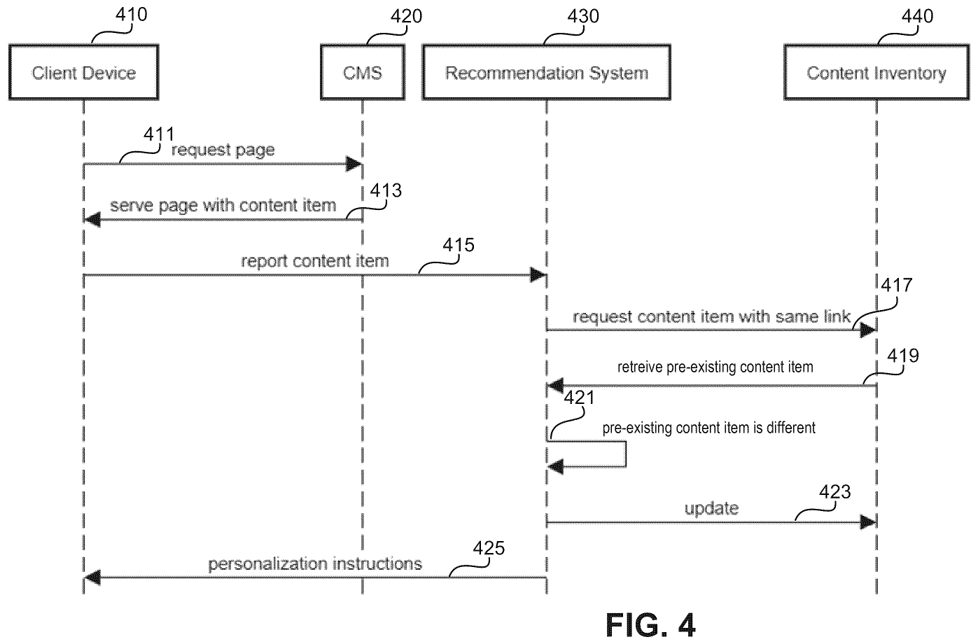

Referring now to FIG. 4, the disclosed subject matter may provide a comprehensive system component interaction sequence that demonstrates the communication flow between multiple system components for content verification, updating, and personalization processes. The sequence may illustrate how distributed system components may coordinate to maintain accurate content inventories while providing personalized content delivery to users. The interaction sequence may address technical challenges associated with maintaining content consistency across multiple system components that may operate independently while requiring coordinated data exchange for effective content management. The sequence may enable real-time content verification and updating mechanisms that may respond to user interactions while maintaining system efficiency and data accuracy.

The interaction sequence may begin when a Client Device 410 initiates content retrieval by transmitting a Message 411 to request a webpage from a CMS 420. Message 411 may comprise a request for specific webpage content. The request message may utilize standard web communication protocols to establish communication channels between Client Device 410 and CMS 420. In some embodiments, Message 411 may include authentication credentials, user identification information, or personalization parameters that may enable CMS 420 to customize content delivery based on user characteristics or preferences.

CMS 420 may process the request received through Message 411 and respond by generating a Message 413 that serves the requested webpage with content items back to Client Device 410. Message 413 may comprise webpage content including textual elements, multimedia files, metadata, interactive components, and embedded content items that may be assembled from content repositories managed by CMS 420. The content serving process may involve retrieving content items from internal content inventories, applying formatting and layout specifications, and preparing content for transmission to Client Device 410. In some embodiments, Message 413 may include content items that have been selected based on editorial decisions, publication schedules, user preferences, or algorithmic recommendations generated by CMS 420.

Following the receipt of webpage content through Message 413, Client Device 410 may analyze the received content to identify individual content items and their associated properties, subsequently transmitting a Message 415 to report the identified content items to a Recommendation System 430. Message 415 may comprise content item information including location identifiers, content properties, metadata, and descriptive information that may characterize the content items for inventory management purposes. The content reporting process may involve parsing webpage structure, extracting content elements, analyzing embedded metadata, and formatting content item information for transmission to Recommendation System 430. In some embodiments, Message 415 may include hash values, content signatures, or other identifying information that may enable efficient content comparison and verification processes within Recommendation System 430.

Recommendation System 430 may receive the content item information through Message 415 and initiate content verification processes by transmitting a Message 417 to request corresponding content items from a Content Inventory 440. Message 417 may comprise queries that utilize location identifiers or other content item characteristics to search for pre-existing content items within Content Inventory 440 that may correspond to the content items reported by Client Device 410. The request process may involve database queries, index searches, or other retrieval mechanisms that may enable efficient location of stored content items within potentially large content inventories. In some embodiments, Message 417 may include search parameters, filtering criteria, or other specifications that may refine the content retrieval process to locate relevant pre-existing content items.

Content Inventory 440 may process the request received through Message 417 and respond by transmitting a Message 419 that provides a pre-existing content item back to Recommendation System 430. Message 419 may comprise stored content item information including properties, metadata, historical versions, and other descriptive data that may enable comparison with the newly reported content items from Client Device 410. The content retrieval process may involve accessing database records, retrieving stored content properties, and formatting content item information for transmission to Recommendation System 430. In some embodiments, Message 419 may include multiple versions of content items, historical change records, or additional contextual information that may support comprehensive content comparison and analysis processes.

In a Process 421, Recommendation System 430 may analyze the content items received through Message 419 in comparison with the content items reported through Message 415 to determine whether differences exist that may indicate content updates or modifications. The Process 421 determination may comprise analysis results, difference indicators, change summaries, or other information that may characterize the nature and extent of detected content differences. The difference determination process may involve property comparisons, content analysis algorithms, similarity calculations, or other analytical mechanisms that may identify meaningful changes between content item versions. Additionally, or alternatively, any changes may suffice to identify that the item is different. Additionally, or alternatively, any changes except for a difference that is caused due to not having a specific property, may be considered sufficient to determine a difference. For example, in some display modalities, the content item may include a media file while in other it may be displayed without it. The lack of a media file may be insufficient to consider the newly identified content item as different. As another example, some display modalities may omit the subtitle. Accordingly, such a difference on its own may be insufficient to consider the newly encountered content item as different from the pre-existing content item.

Based on the difference determination of Process 421, Recommendation System 430 may transmit a Message 423 to Content Inventory 440 to initiate content inventory update processes. Message 423 may comprise update instructions, revised content item properties, new metadata values, or other information that may enable Content Inventory 440 to modify stored content item records to reflect current content states. The update message may specify which content item properties should be modified, which historical records should be maintained, which inventory management protocols should be applied during the update process, or the like.

The interaction sequence may conclude when Recommendation System 430 transmits a Message 425 that provides personalization instructions back to Client Device 410. Message 425 may comprise content recommendations, personalization parameters, content modification instructions, or other guidance that may enable Client Device 410 to customize content presentation based on updated content inventory information and user preferences. The personalization instructions may include content item selections, display modifications, interactive element configurations, or other specifications that may enhance user experience through tailored content delivery. In some embodiments, Message 425 may include real-time content updates, dynamic content replacements, or other modifications that may ensure users receive current and relevant content based on the most recent content inventory information maintained by Content Inventory 440 and processed by Recommendation System 430.

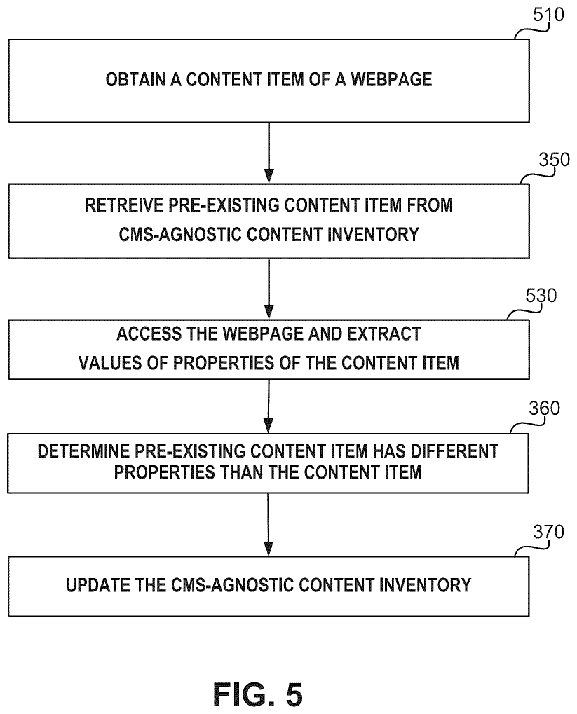

Referring now to FIG. 5, the disclosed subject matter provides a method for updating a CMS-agnostic content inventory through direct webpage access and property extraction mechanisms. The method may implement content analysis processes that may operate independently of client device interactions while maintaining accurate content inventory records across distributed systems. The approach may address technical challenges associated with detecting content updates that may not be reflected in traditional metadata fields such as modification timestamps, thereby enabling more reliable content inventory management through direct content analysis and property comparison mechanisms.

The method may begin at a Step 510 where a content item of a webpage may be obtained for processing within a content inventory update system. Step 510 may involve receiving content item information that includes location identifiers and associated properties that may characterize the content item for inventory management purposes. The content acquisition process may involve extracting content item details from various sources including client device reports, content management system notifications, or automated content discovery mechanisms. In some embodiments, Step 510 may implement content validation processes that may verify the completeness, accuracy, and the like of received content item information before proceeding with inventory update operations. The content item obtained through Step 510 may include descriptive properties such as titles, authors, media files, publication dates, or other metadata elements that may enable comprehensive content analysis and comparison processes.

The method may proceed to Step 350 where a pre-existing content item may be retrieved from the CMS-agnostic content inventory using the location identifier associated with the content item obtained in Step 510.

Following the retrieval of pre-existing content items, the method may advance to a Step 530 where the webpage may be accessed at the location identifier of the content item and values for the one or more properties may be extracted from the webpage. Step 530 may implement direct webpage access mechanisms that may operate independently of the user device, thereby enabling autonomous content analysis and property extraction processes without adding computational or communicational load to the client device. The webpage access process may involve establishing network connections to content servers, retrieving webpage content including HTML markup, embedded media files, and associated metadata, and parsing webpage structure to identify discrete content elements and their associated properties. In some embodiments, Step 530 may implement content parsing algorithms, or automated analysis tools that may extract property values from various webpage elements including titles, descriptions, author information, publication dates, media files, and other descriptive content characteristics.

Step 530 may implement property extraction mechanisms that may analyze webpage content to identify and extract relevant property values that may characterize the content item for inventory management purposes. The extraction process may involve parsing Hypertext Markup Language (HTML) markup to locate specific content elements, analyzing metadata tags to extract descriptive information, processing embedded media files to determine content characteristics, and applying natural language processing techniques to extract semantic information from textual content. In some embodiments, the property extraction process may implement threshold-based approaches where engagement rate differences between newer and older content items may trigger update checks when exceeding certain thresholds, thereby enabling the system to prioritize content updates based on relative engagement performance metrics. The extraction mechanisms may also weight different types of user interactions differently, with social media shares and comments having higher weight than simple page views for triggering update checks, thereby enabling more nuanced assessment of content relevance and update priority.

It is noted that Step 530 may involve accessing the underlying item itself and not merely relying on a content item description thereof.

In some cases, Step 530 may be performed with respect to a specific article or item only if it was not visited in a recent time window (e.g., 10 minutes, 1 hour, 5 seconds, or the like), to avoid multiple redundant access requests.

The method may continue to Step 360 where a determination may be made whether the pre-existing content item may have different properties than the content item based on the property values extracted through Step 530m and to Step 370 where the CMS-agnostic content inventory is updated.

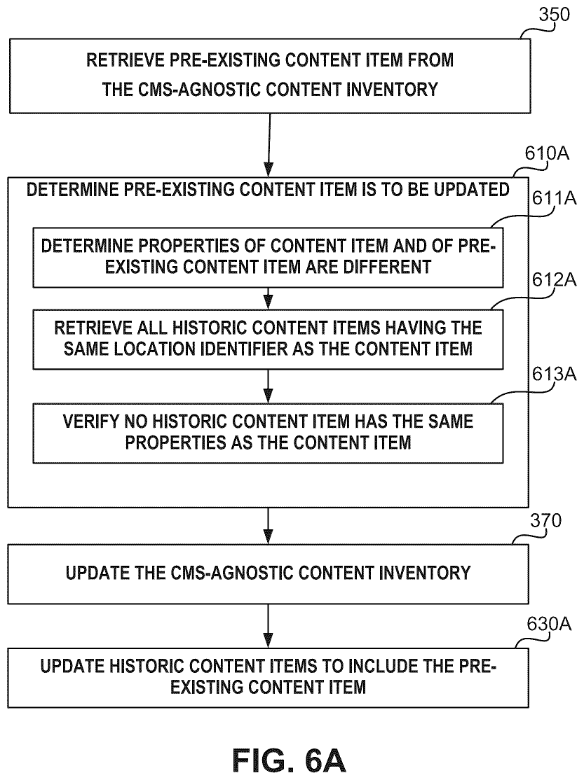

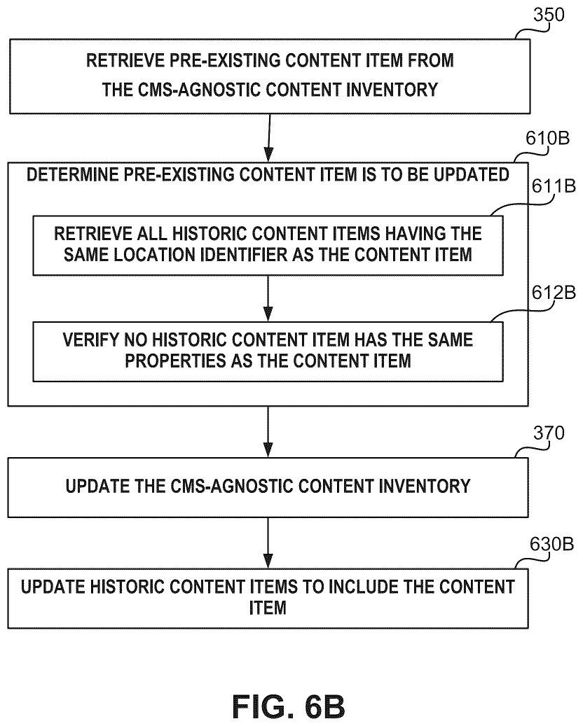

Referring now to FIG. 6A, the disclosed subject matter provides a comprehensive historic content verification process that may implement mechanisms for preventing the reintroduction of outdated content versions into the CMS-agnostic content inventory. The process may address technical challenges associated with maintaining content inventory integrity when content items undergo multiple revisions over time, ensuring that previously seen content versions may not inadvertently replace more current content states. The historic content verification approach may enable robust content management by maintaining detailed records of all content item versions while implementing verification protocols that may prevent regression to earlier content states that may no longer be accurate or relevant.

The historic content verification process may begin at the Step 350 where a pre-existing content item may be retrieved from the CMS-agnostic content inventory based on location identifier matching with a newly received content item. The Step 350 may establish the foundation for content comparison by providing access to the pre-existing content item that may be the most current version of the newly received content item that may be stored within the CMS-agnostic content inventory system. Following the retrieval of the pre-existing content item, the process may advance to a Step 610A where a determination may be made that the pre-existing content item may be updated based on comprehensive analysis of properties of the newly received content item and historic content records.

Within Step 610A, several sub-steps may be implemented. Steps 611A, 612A, and 613A may collectively ensure content inventory integrity through property analysis and historic content tracking. Step 611A may involve determining that the properties of the newly retrieved content item and the properties of the pre-existing content item are different, thereby establishing that content changes have occurred that may warrant inventory updates. When Step 611A has determined differences between the newly retrieved content item and the pre-existing content item, the process may continue with Step 612A where all historic content items having the same location identifier as the content item may be retrieved from the inventory of historic content items. Step 612A may implement comprehensive database queries that may access historical content records to locate all previously stored versions of the content item based on location identifier matching. The historic content retrieval process may involve accessing distributed database systems, performing index searches across historical archives, and assembling complete content version histories that may enable thorough analysis of content evolution patterns. Step 612A may ensure that the process may have access to complete historical context when evaluating whether newly received content properties may represent genuine updates or may correspond to previously seen content states that should not be reintroduced into the active content inventory.

Following the retrieval of historic content items, the process may proceed to Step 613A where verification may be performed to ensure that no historic content item may have the same properties as the newly received content item being processed for inventory updates. Step 613A may determine whether the newly received content item may correspond to a previously seen content version that should not be reintroduced into the active inventory. Step 613A may prevent old versions from being reintroduced to the CMS-agnostic content inventory.

The historic content verification mechanisms implemented through Step 613A may address scenarios where old versions resurface due to caching mechanisms that are implemented on the web. The fact that one client device received an old version from a server that cached the old version and did access the CMS to obtain the most up-to-date version should not cause the system to remove the newer version and revert to the old version.

When the verification process determines that the content item properties may not match any historic content item properties, the process may proceed to Step 370 where the CMS-agnostic content inventory may be updated with the verified newly received content item information.

On Step 630A historic content items may be updated to include the pre-existing content item that was replaced during the inventory update process. Step 630A may implement historical record management mechanisms that may preserve the pre-existing content item within the inventory of historic content items, thereby maintaining complete content version histories that may support future verification processes and content management analytics. Step 630A may ensure that updating an inventory, for example a CMS-agnostic content inventory, of historic content items may include the pre-existing content item, thereby creating comprehensive historical records that may enable the system to detect future content regression scenarios and maintain long-term content inventory integrity. The historical record update process may involve archiving the pre-existing content item with appropriate timestamps, version identifiers, and contextual information that may enable future analysis of content evolution patterns and verification of content update decisions.

Referring now to FIG. 6B, the disclosed subject matter provides an alternative content history management process compared to FIG. 6A.

Following the retrieval of the pre-existing content item in Step 350, the process may advance to a Step 610B, similar to Step 610A, where a determination may be made that the pre-existing content item may be updated based on analysis of content properties and verification protocols. Step 610B may may comprise Step 611B and Step 612B. Step 610B may implement decision logic that may evaluate whether the newly received content item may represent a legitimate update that should be applied to the content inventory.

On Step 611B all historic content items having the same location identifier as the content item may be retrieved from an inventory of historic content items, for example a CMS-agnostic Content Inventory.

The historic content retrieval mechanisms implemented through the Step 611B may address various content management scenarios including live event reporting where content items may undergo rapid updates as events unfold. In some embodiments, the pre-existing content item may be a report of a live event, wherein the content item may be an updated report of the live event that replaces the pre-existing content item. The live event reporting scenario may involve content items that may change frequently as new information becomes available, requiring efficient verification mechanisms that may distinguish between legitimate updates and potential content regression scenarios. The Step 611B may retrieve historic content items that may include previous versions of live event reports, enabling the system to track content evolution patterns and verify that newly received content may represent forward progress in event coverage rather than reversion to earlier reporting states.

On Step 612B, verification may be performed to ensure that no historic content item may have the same properties as the newly received content item being processed for inventory updates. Step 612B may prevent old versions from being reintroduced to the CMS-agnostic content inventory by implementing safeguards that may reject content updates when the proposed changes may match previously stored content states.

In some embodiments, the verification mechanisms implemented through the Step 610B may address complex scenarios involving content items with modification times that may not accurately reflect content changes. In some embodiments, the content item may comprise a modification time property which may be configured to be displayed in the webpage. The pre-existing content item may have a same modification time as the modification time of the content item, whereby the pre-existing content item may be updated in the CMS-agnostic content inventory regardless of a lack of update indication from modification time properties. The modification time handling capabilities may enable the system to detect content changes that may not be reflected in traditional timestamp metadata, ensuring that content inventory updates may occur based on actual content property analysis rather than relying solely on modification time indicators that may be unreliable, inaccurate, or overtaken by developing events.

When the verification process determines that the content item properties may not match any historic content item properties, the process may proceed to a Step 370 where the CMS-agnostic content inventory may be updated with the verified newly received content item information.

The content history management process may conclude with a Step 630B where historic content items may be updated to include the content item that was processed through the verification and update procedures. Step 630B may implement historical record management mechanisms that may preserve the newly processed content item within the inventory of historic content items, thereby maintaining comprehensive content version histories that may support future verification processes and content management analytics. Step 630B may ensure that the inventory of historic content items may be continuously updated to include all content versions that have been processed through the content inventory management system, creating comprehensive historical records that may enable detection of future content regression scenarios and support long-term content inventory integrity maintenance. The historical record update process may involve archiving the processed pre-existing content item with appropriate version identifiers, timestamps, and contextual information that may enable future analysis of content evolution patterns and verification of content management decisions across distributed content management systems.

It is noted that in FIG. 6A the historic record exclude the current, up-to-date version while in FIG. 6B the historic records include the current, up-to-date version.

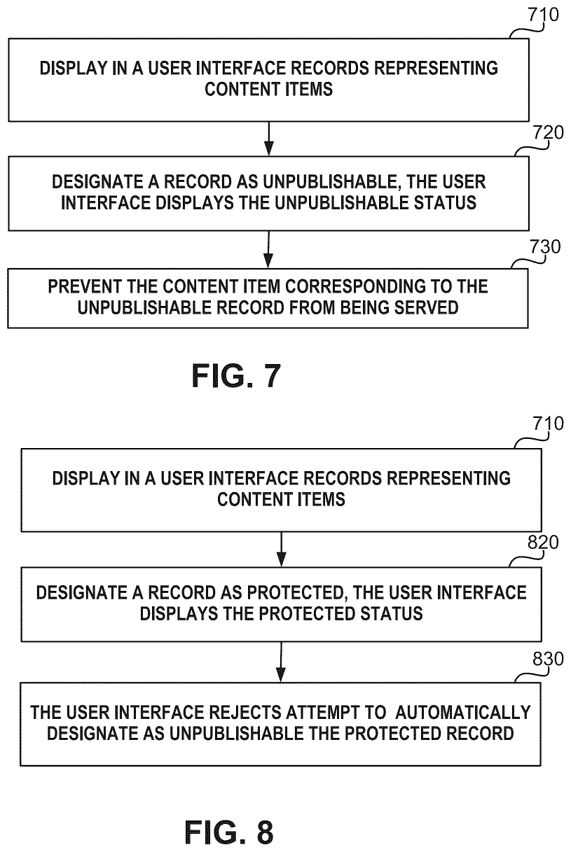

Referring now to FIG. 7, in some embodiments the disclosed subject matter may provide a comprehensive method for managing unpublishable content through user interface mechanisms that enable content curation while maintaining automated decision-making capabilities. The method may implement content management processes that allow content administrators to designate content items as unpublishable through both automated and manual mechanisms, thereby providing flexible content curation tools that may balance efficiency with editorial control. The user interface may be configured to assist an administrator of the webpage in curating potential content recommendations to users visiting the webpage, enabling comprehensive oversight of content serving decisions while providing visual feedback and control mechanisms for content management operations.

On Step 710, the method may display in a user interface a plurality of records representative of a plurality of content items that are publishable on a webpage, wherein each of the plurality of records may comprise data descriptive of a corresponding content item. Step 710 may implement comprehensive content presentation mechanisms that organize content items in tabular or list formats, enabling content administrators to review multiple content items simultaneously while accessing relevant metadata, performance metrics, and status information for each content item. The display process may involve retrieving content item information from content inventories, formatting content data for presentation, and organizing content records according to various sorting and filtering criteria that may enable efficient content review and management operations. In some embodiments, the webpage may be published using a CMS having a content inventory, wherein a Content Recommendation System may comprise a CMS-agnostic content inventory, wherein the content recommendation system may be configured to serve content recommendations based on the CMS-agnostic content inventory, and wherein the user interface may be a user interface of the Content Recommendation System.

The method may proceed to Step 720 where a content item of the plurality of content items may be designated as unpublishable, wherein the user interface may be updated to reflect the content item being designated as unpublishable. Step 720 may implement designation mechanisms that enable both automated and manual content management decisions, providing flexibility in content curation approaches while maintaining consistent user interface feedback for all designation operations. The designation process may involve updating content item status indicators, modifying visual presentation elements, and triggering notification mechanisms that inform content administrators of designation changes. In some embodiments, the designating may be performed automatically and without user intervention, enabling efficient content management through algorithmic decision-making processes that may analy ze content characteristics, performance metrics, expiration times, and other factors to determine when content items should be designated as unpublishable.

Step 720 may implement automated designation mechanisms that may be performed at an expiration time of the content item, wherein the expiration time may be displayed visually in the user interface. The automated designation process may monitor content item expiration times and automatically update content status when expiration time thresholds are reached, thereby ensuring that outdated content may be prevented from being served to users without requiring manual intervention from content administrators. The visual display of expiration times may provide content administrators with temporal context for content management decisions, enabling proactive content curation based on predicted content lifecycle patterns. In some embodiments, the user interface may be updated to reflect the content item being designated as unpublishable and may further comprise enabling the user interface to display a reason for designating the content item as unpublishable, thereby providing transparency and accountability for automated content management decisions. In some embodiments, the reason may generated automatically, composed and edited by an administrator, or any combination thereof.

The designation mechanisms implemented through Step 720 may also accommodate manual content management approaches where the designating may be based on a user input that manually designates the content item as unpublishable. The manual designation capabilities may enable content administrators to override automated decision-making processes when editorial judgment indicates that content items should be designated as unpublishable, for example based on factors that may not be captured through algorithmic analysis. The user interface may provide interactive elements such as buttons, checkboxes, widgets, or menu options that enable content administrators to manually designate content items as unpublishable while providing immediate visual feedback regarding designation status changes. The combination of automated and manual designation mechanisms may provide comprehensive content management capabilities that balance efficiency with editorial control, enabling content administrators to benefit from automated content curation while maintaining oversight and intervention capabilities when necessary.

The method may conclude with Step 730 where the content item may be prevented from publishing on the webpage due to the unpublishable designation. Step 730 may implement content serving prevention mechanisms that ensure that content items designated as unpublishable may not be delivered to users through content distribution channels, for example content management systems, recommendation engines, search results, or personalized content delivery systems. The prevention process may involve updating content serving algorithms, modifying content inventories, implementing filtering mechanisms within content distribution systems. Coordinating with multiple system components may ensure comprehensive content blocking across distributed content management architectures. In some embodiments, Step 730 may maintain audit trails of prevention decisions, enabling content administrators to track content management actions and analyze patterns of content designation and prevention operations over time.

Referring now to FIG. 8, the disclosed subject matter may provide a complementary method for managing protected content compared to FIG. 7, that may implement safeguards against inadvertent content removal through automated processes. The method may address scenarios where specific content items may be incorrectly identified for unpublishing through automated content management algorithms. the method may provid protection mechanisms that enable content administrators to preserve content items that should remain available for serving to users regardless of automated decision-making processes. The protected content management approach may enable organizations to benefit from automated content curation while ensuring that content items may be protected from automated unpublishing when editorial judgment indicates that such content should remain available for user access.

On Step 710, the method may display in a user interface a plurality of records representative of a plurality of content items that are publishable on a webpage, wherein each of the plurality of records may comprise data descriptive of a corresponding content item. Step 710 may provide the same comprehensive content presentation capabilities as described in the unpublishable content management process, enabling content administrators to review content items while accessing protection status information and control mechanisms for designating content items as protected from automated unpublishing processes. The display mechanisms may include visual indicators that distinguish between protected and unprotected content items, enabling content administrators to quickly identify content protection status while reviewing content inventories and making content management decisions.

The method may advance to an Step 820 where a record may be designated as protected, wherein the user interface may be updated to display the protected status. Step 820 may implement protection designation mechanisms that enable content administrators to manually identify content items that should be shielded from automated unpublishing processes, providing editorial override capabilities that may prevent valuable content from being inadvertently removed through algorithmic decision-making. The protection designation process may involve updating content item metadata, modifying visual presentation elements within the user interface, and configuring content management systems to recognize and respect protection status when evaluating content items for automated unpublishing operations. In some embodiments, the protection designation may be applied to various content types, for example evergreen content, high-performing content items, or content that may have strategic value that extends beyond typical content lifecycle patterns captured through automated analysis algorithms.

Step 820 may provide content administrators with granular control over content protection decisions, enabling selective application of protection status based on editorial judgment, content performance metrics, strategic considerations, or other factors that may not be adequately captured through automated content analysis processes. The user interface may provide interactive elements such as protection toggles, status indicators, or confirmation dialogs that enable content administrators to designate content items as protected while providing immediate visual feedback regarding protection status changes. The protection designation capabilities may be integrated with content management workflows, enabling content administrators to apply protection status during content creation, review, or ongoing content management operations as part of comprehensive content curation processes.

The method may conclude with a Step 830 where the user interface may reject an attempt to automatically designate as unpublishable the protected record. Step 830 may implement protection enforcement mechanisms that prevent automated content management processes from designating protected content items as unpublishable, thereby ensuring that editorial protection decisions may override algorithmic content management recommendations. The rejection process may involve intercepting automated unpublishing attempts, generating notification messages that inform content administrators of protection conflicts, and maintaining audit trails that document protection enforcement actions for content management accountability and analysis purposes. In some embodiments, a content item that may be designated as protected cannot be designated automatically as unpublishable, thereby providing absolute protection against automated content removal while still enabling manual override capabilities when content administrators determine that protected content should be unpublished based on changing circumstances or editorial decisions.

Step 830 may implement protection logic that may distinguish between automated and manual content management actions, enabling protected content items to be manually unpublished by content administrators while preventing automated systems from designating such content as unpublishable. The protection enforcement mechanisms may provide notification capabilities that alert content administrators when automated systems attempt to unpublish protected content, enabling review of protection decisions and potential adjustment of protection status when circumstances warrant changes to content protection policies. The rejection mechanisms may also provide reporting capabilities that enable content administrators to analyze patterns of protection conflicts, identify content items that may be frequently targeted for automated unpublishing despite protection status, and refine content protection strategies based on observed automated content management behaviors and protection enforcement outcomes.

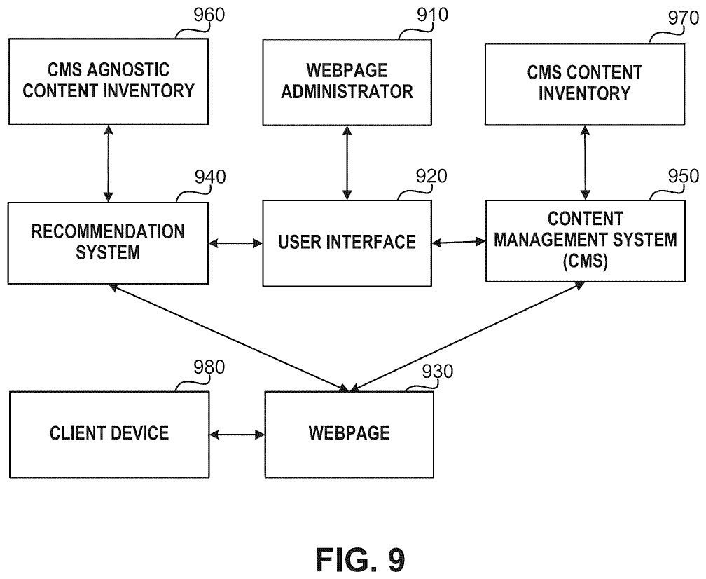

Referring now to FIG. 9, the disclosed subject matter may provide a comprehensive content management system architecture that may implement distributed processing capabilities across multiple interconnected components to enable content curation, recommendation, and inventory management operations. The architecture may address technical challenges associated with coordinating content management activities across heterogeneous systems while maintaining data consistency, enabling real-time content updates, and providing comprehensive user interface capabilities for content administration. The system architecture may enable scalable content management operations that may accommodate multiple content sources, diverse content types, and varying content management requirements while providing unified control and monitoring capabilities through integrated user interface mechanisms.

A Webpage Administrator 910 may serve as the primary human interface point to a User Interface 920 within the content management system architecture, providing editorial oversight and administrative control over content management operations. The Webpage Administrator 910 may interact with User Interface 920 to configure content management policies, review content performance metrics, make editorial decisions regarding content publishing and unpublishing, and monitor system operations to ensure content quality and relevance standards. The Webpage Administrator 910 may have access to comprehensive content management tools that enable both automated and manual content curation approaches, providing flexibility in content management strategies while maintaining editorial control over content serving decisions. In some embodiments, the Webpage Administrator 910 may interact with User Interface 920 to configure content categorization rules, expiration time parameters, protection policies for specific content items, and other administrative settings that may influence automated content management behaviors across the distributed system architecture.

The system architecture may incorporate a User Interface 920 that may provide comprehensive content management capabilities through visual presentation mechanisms and interactive control elements. The User Interface 920 may display for example content inventories, performance metrics, content status information, and administrative controls, all of which may enable the Webpage Administrator 910 to efficiently manage large volumes of content items while maintaining visibility into system operations and content performance patterns. The User Interface 920 may implement filtering, sorting, and search capabilities that enable content administrators to locate specific content items, analyze content performance trends, and make informed decisions regarding content management operations.

In some embodiments, the User Interface 920 may provide batch operation capabilities that enable simultaneous management of multiple content items, thereby improving administrative efficiency while maintaining granular control over individual content management decisions. Batch operations may comprise flagging and unflagging multiple content items simultaneously. The batch operation capabilities may include selection mechanisms that enable content administrators to identify groups of content items based on various criteria, for example publication dates, performance metrics, content categories, or expiration status. The User Interface 920 may highlight flagged content items, for example with distinct background colors enabling content administrators to quickly distinguish between content items that require attention and content items that may be managed through automated processes.

In some embodiments, the User Interface 920 may include a time period filter that allows users to filter displayed content items based on specific time periods for a more tailored view, enabling focused content management activities based on temporal criteria that may be relevant for specific content management objectives.

A Webpage 930 may serve as the content delivery mechanism that presents content items to end users through web-based interfaces that may be accessed through various client devices, for example Client Device 980, which may comprise a web browser and enable an end user to access web content. The Webpage 930 may be published using a CMS 950 having a CMS Content Inventor 970, a Recommendation System 940, or other means, wherein the content serving process may involve retrieving content items from content repositories, applying formatting and presentation specifications, and delivering content to users based on personalization algorithms and content recommendation mechanisms. The Webpage 930 may implement dynamic content serving capabilities that may adapt content presentation based on user preferences, browsing history, demographic information, and real-time content availability within the content management system architecture. In some embodiments, the Webpage 930 may incorporate content recommendation features that may suggest related content items, provide personalized content selections, and enable user interaction mechanisms that may influence future content recommendations and personalization algorithms.

The system architecture may include a Recommendation System 940 that may implement content analysis and recommendation algorithms to provide personalized content delivery and automated content management capabilities. The Recommendation System 940 may analyze user behavior patterns, content performance metrics, and content characteristics to generate content recommendations that may enhance user engagement while supporting content discovery and consumption objectives. The Recommendation System 940 may coordinate with other system components to maintain current content inventories, detect content updates, and implement content serving policies that may balance automated efficiency with editorial oversight requirements.

The Recommendation System 940 may implement artificial intelligence-powered sentiment analysis by analyzing user comments, social media reactions, and engagement forms to gauge public interest and adjust expiration dates, thereby providing dynamic content management capabilities that may respond to changing user preferences and content relevance patterns. The sentiment analysis capabilities may enable the Recommendation System 940 to detect shifts in user interest or engagement that may indicate when content may become less relevant to audiences, supporting automated content lifecycle management decisions. The Recommendation System 940 may use a hybrid approach combining rule-based and probabilistic methods for expiration prediction, applying hard rules while calculating probability of relevance, thereby providing flexible content management approaches that may accommodate various content types and management requirements while maintaining consistency in content serving decisions.

CMS 950 may provide core content storage, retrieval, and management capabilities that support content publication workflows and content serving operations across the distributed system architecture. The CMS 950 may implement database management mechanisms, for example requesting database services from CMS Content Inventory 970. CMS Content Inventory 970 may comprise content indexing capabilities, and content serving protocols that enable efficient content operations while maintaining data integrity and system performance standards. The CMS 950 may coordinate with the Recommendation System 940 and other system components to ensure content consistency, support content update detection mechanisms, and implement content serving policies that may reflect current content management objectives and editorial decisions. In some embodiments, the CMS 950 may maintain comprehensive audit trails of content management activities, enabling content administrators to track content lifecycle events, analyze content performance patterns, and optimize content management strategies based on observed system behaviors and content consumption metrics.

The system architecture may incorporate a Recommendation System 940 that may provide unified content tracking and management capabilities across multiple CMS platforms and systems. Recommendation System 940 may implement cross-platform content management mechanisms that enable consistent content tracking regardless of the underlying CMS implementations, thereby providing flexibility in content management approaches while maintaining unified content oversight capabilities.

A CMS Agnostic Content Inventory 960 may maintain comprehensive content metadata, version histories, and content relationship information that may support content management operations including content update detection, duplicate content prevention, and content lifecycle management across distributed content management environments. In some embodiments, a CMS Agnostic Content Inventory 960 may implement content synchronization mechanisms that may coordinate content updates across multiple content management systems while preventing content conflicts and maintaining data consistency across the distributed architecture.

A CMS Agnostic Content Inventory 960 may maintain a database of average content lifespans for different categories and use this as a baseline for expiration predictions, enabling content management decisions that may be informed by historical content performance patterns and category-specific content lifecycle characteristics. A Recommendation System 940 may trigger content update checks based on user interactions with related content items, not just the same content item, thereby enabling comprehensive content management approaches that may consider content relationships and user engagement patterns when determining content update priorities and content serving decisions.

The system architecture may include a Recommendation System 940 that may provide content management system-specific content storage and management capabilities that may be integrated with the broader content management architecture while maintaining compatibility with existing content management workflows and systems. A Recommendation System 940 may implement content management system-specific data structures, content organization mechanisms, and content serving protocols that may be optimized for particular content management platform requirements while enabling integration with the CMS Agnostic Content Inventory 960 and other system components. In some embodiments, A CMS Content Inventory 970 may implement content validation mechanisms, content quality assurance processes, and content management audit capabilities that may ensure content integrity and compliance with content management policies while supporting efficient content operations across the integrated system architecture.

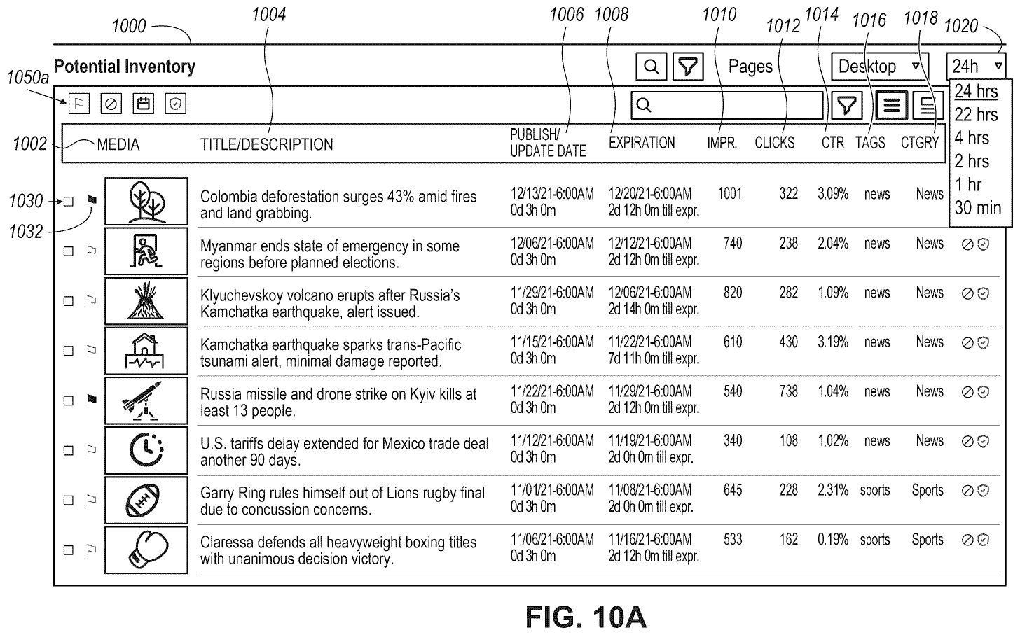

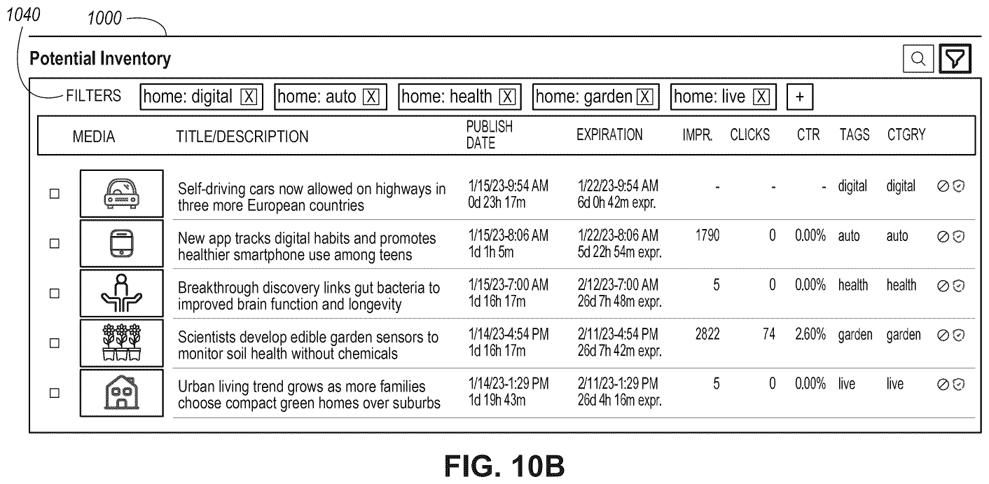

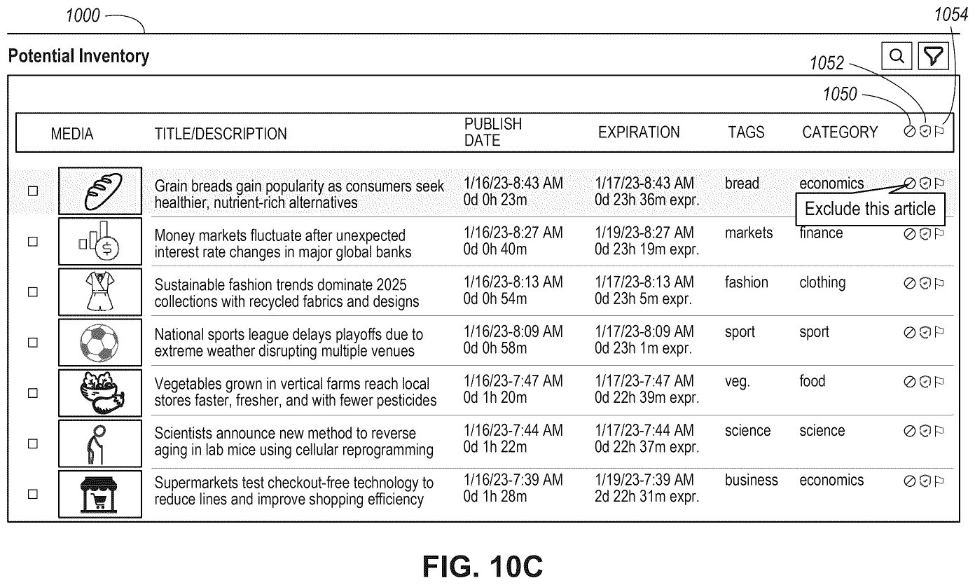

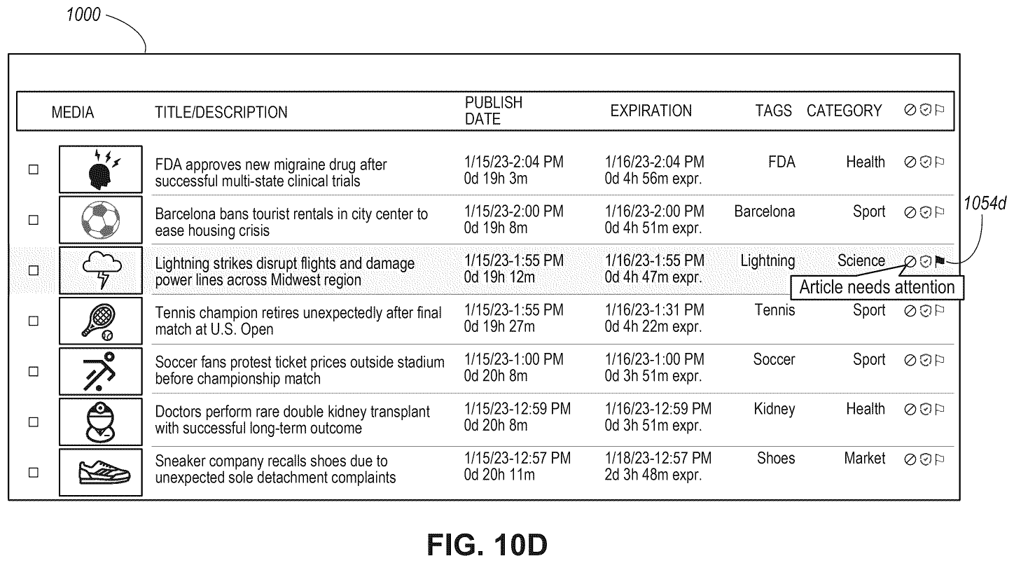

Referring now to FIG. 10A, the disclosed subject matter may provide a Content Inventory Management Interface 1000 that may implement performance tracking and content organization capabilities through visual presentation mechanisms and interactive control elements. The interface may address technical challenges associated with managing large volumes of content items while providing content administrators with comprehensive visibility into content performance metrics, engagement patterns, and content lifecycle information that may inform content management decisions. The interface may enable efficient content review and curation processes through tabular data organization, filtering capabilities, and integrated performance analytics that may support both automated and manual content management approaches across distributed content management systems.

Content Inventory Management Interface 1000 may display a potential inventory of records corresponding to and representing content items, and may organize the records in a structured tabular format, enabling content administrators to review multiple content records simultaneously while accessing relevant metadata, performance metrics, and status information for each content record. The Content Inventory Management Interface 1000 may implement comprehensive data presentation mechanisms that may provide visual organization of records according to various characteristics including publication information, performance data, categorization details, and temporal attributes that may enable efficient content analysis and management operations. The tabular layout may facilitate comparative analysis of content items by presenting standardized information fields in consistent column structures, thereby enabling content administrators to identify patterns, trends, and outliers within content inventories that may inform content curation strategies and editorial decisions. The Potential Inventory 1000 may support scalable content management operations by accommodating varying numbers of content items while maintaining consistent presentation formats and interactive capabilities across different content inventory sizes and complexity levels.

The interface may incorporate a Media Section 1002 that may display visual representations of content items through thumbnail images, icons, or other graphical elements that may provide immediate visual identification of content types and subject matter characteristics. A Media Section 1002 may implement multimedia presentation capabilities that may enable content administrators to quickly assess content visual characteristics without requiring detailed examination of individual content items, thereby improving content review efficiency and enabling rapid content categorization based on visual elements. The visual presentation mechanisms within the Media Section 1002 may support various content types including images, videos, documents, and other multimedia elements, providing consistent visual representation approaches across diverse content formats while maintaining interface usability and performance standards.

A Title Description 1004 may provide comprehensive textual identification of content items through display of titles, descriptions, and other textual metadata that may characterize content subject matter, scope, and relevance for content management purposes. The Title Description 1004 may implement text presentation mechanisms that may enable content administrators to assess content topics, themes, and editorial focus without requiring access to full content text, thereby supporting efficient content review processes and enabling rapid content categorization based on textual analysis. The textual presentation capabilities may accommodate varying content description lengths and complexity levels while maintaining consistent formatting and readability standards across different content types and sources. In some embodiments, the Title Description 1004 may provide interactive text editing capabilities that may enable content administrators to modify content titles, descriptions, or other textual metadata directly within the interface, supporting content optimization and editorial refinement processes as part of comprehensive content management workflows.

The interface may include a Publish/Update Date 1006 that may display temporal information regarding content publication times and modification times, histories, or both, enabling content administrators to assess content freshness, patterns of updating, and temporal relevance for content lifecycle management decisions. A Publish/Update Date 1006 may implement date presentation mechanisms that may provide chronological context for content items, supporting content expiration analysis, update scheduling, and temporal content organization approaches that may enhance content management efficiency and accuracy. The temporal information display may accommodate various date formats and time zone considerations while maintaining consistent presentation standards across different content sources and management systems. The publication time information may enable content administrators to identify content items that may require review, updating, or removal based on temporal criteria that may be relevant for specific content management objectives, content categories, editorial policies and the like.

An Expiration Date 1008 may provide visibility into predicted or calculated content lifecycle endpoints, enabling content administrators to assess when content items may become outdated or less relevant for serving to users. The Expiration Date 1008 may implement temporal prediction display mechanisms that may present expiration time information calculated through machine learning algorithms, content analysis processes, or manual editorial decisions, thereby providing content administrators with forward-looking content management information that may support proactive content curation strategies. The expiration date presentation may enable content administrators to identify content items that may be approaching expiration thresholds, requiring editorial review, or warranting protection from automated unpublishing processes based on content value assessments and strategic considerations. In some embodiments, the interface may enable manual editing of the expiration time through interactive elements associated with the Expiration Date 1008, providing content administrators with direct control over content lifecycle parameters while maintaining integration with automated expiration prediction mechanisms and content management workflows.

The interface may incorporate display of performance tracking capabilities through an Impression Counter 1010, a Clicks Counter 1012, and a Clicks Through Rate 1014 that may provide quantitative metrics regarding content engagement, user interaction patterns, and content effectiveness measurements. The Impression Counter 1010 may display the number of times content items have been presented to users, providing visibility into content exposure levels and reach metrics that may inform content promotion and distribution decisions. The Clicks Counter 1012 may track user interaction events including clicks, selections, or other engagement actions that may indicate content relevance and user interest levels, enabling content administrators to assess content performance based on actual user behavior patterns. The Clicks Through Rate 1014 may calculate and display engagement ratios, for example (Number of Clicks): (Number of Views or Impressions)×100%, that may provide normalized performance metrics enabling comparative analysis of content effectiveness across different content items, categories, and time periods, thereby supporting data-driven content management decisions and performance optimization strategies.

The performance tracking display mechanisms may enable content administrators to identify high-performing content items that may warrant protection from automated unpublishing processes, content items with declining engagement that may require editorial review or removal, content performance trends that may inform content creation and curation strategies, and the like. The quantitative performance data may support threshold-based content management approaches where content items with performance metrics below specified levels may be automatically flagged for review or designated as candidates for unpublishing based on engagement criteria. In some embodiments, the performance metrics may be integrated with content recommendation algorithms and personalization systems, enabling content serving decisions that may prioritize high-performing content while reducing exposure of content items with poor engagement metrics.

A Tag Section 1016 may display content classification information through keyword tags, topic labels, or other categorical identifiers that may enable content organization, search, and filtering operations within the content management interface. The Tag Section 1016 may implement content categorization display mechanisms that may provide semantic organization of content items based on subject matter, themes, or other content characteristics that may support content discovery and management processes. The tag presentation capabilities may accommodate both manually assigned tags and automatically generated classification labels, providing flexible content organization approaches that may balance editorial control with automated content analysis capabilities. In some embodiments, the Tag Section 1016 may provide interactive tag editing capabilities that may enable content administrators to modify content classifications, add new tags, or remove inappropriate labels as part of ongoing content curation and optimization processes.

A Category Section 1018 may provide higher-level content classification information that may organize content items into broad subject areas, content types, or editorial categories that may support content management workflows and content serving strategies. The Category Section 1018 may implement hierarchical content organization mechanisms that may enable content administrators to manage content inventories based on categorical structures that may align with editorial policies, audience segmentation approaches, or content distribution strategies. The category information may be automatically generated based on information associated with content items including textual analysis, metadata examination, or machine learning classification processes that may analyze content characteristics to determine appropriate categorical assignments. In some embodiments, the categorical information may be manually assigned or modified by content administrators, providing editorial oversight of content classification processes while enabling integration with automated categorization mechanisms and content management systems.

In some embodiments, the interface may incorporate a Time Filter 1020 that may enable content administrators to filter displayed content items based on specific time periods, providing temporal content management capabilities that may support focused content review and analysis operations. The Time Filter 1020 may implement date range selection mechanisms that may enable content administrators to examine content items published within particular timeframes, approaching expiration within specified periods, exhibiting performance patterns during defined temporal intervals, and the like. The temporal filtering capabilities may support various content management scenarios including periodic content reviews, seasonal content management, event-based content curation, and performance analysis activities that may require examination of content subsets based on temporal criteria. The Time Filter 1020 may provide a more tailored view of content inventories by enabling content administrators to focus on content items that may be relevant for specific time-based content management objectives while reducing interface complexity and improving content review efficiency. In some embodiments, the Time Filter 1020 may enable manually selecting both a time period and a criteria to be met within the time period, for example selecting a time period of May-June 2024, and selecting a criteria of a click-through-rate above 20%.

A Content Item Select 1030 may provide selection mechanisms that may enable content administrators to identify individual content items or groups of content items for batch operations, detailed examination, or targeted management actions. The Content Item Select 1030 may implement checkbox interfaces, selection toggles, or other interactive elements that may enable content administrators to mark content items for subsequent processing through batch operations or individual content management actions. The selection capabilities may support various content management workflows, for example bulk content updates, group content protection assignments, simultaneous content flagging operations, coordinated content publishing or unpublishing actions, and the like.

An Attention Flag 1032 may provide visual indicators that may enable content administrators to mark content items requiring review, editorial attention, or special handling within content management workflows. The Attention Flag 1032 may implement flagging mechanisms that may enable content administrators to identify content items that may require manual review, editorial updates, or other attention-based processing that may not be addressed through automated content management processes. The flagging capabilities may support collaborative content management approaches where multiple content administrators may coordinate content review and curation activities through shared flagging systems that may track content items requiring attention across distributed content management teams and workflows.

The interface may incorporate a Batch Operations Widget 1050a that may enable simultaneous management of multiple content items through coordinated actions that may improve administrative efficiency while maintaining control over individual content management decisions. The Batch Operations Widget 1050a may implement batch operation capabilities that may enable flagging and unflagging multiple content items simultaneously, thereby improving management efficiency through coordinated processing of content item groups rather than requiring individual content item management actions. The batch processing mechanisms may support various batch content management operations, for example simultaneous content protection assignments, coordinated content unpublishing actions, batch content categorization updates, and bulk content metadata modifications. In some embodiments, the Batch Operations Widget 1050a may provide confirmation mechanisms, operation previews, or rollback capabilities that may ensure batch operations may be performed accurately and safely while enabling content administrators to verify batch operation results and make corrections when necessary.

Referring now to FIG. 10B, the disclosed subject matter may provide a category-based content filtering interface that may implement content organization and navigation mechanisms to enable targeted content management operations across large content inventories. The interface may address technical challenges associated with managing diverse content types and subject matters by providing categorical organization structures that may enable content administrators to focus on specific content segments while maintaining comprehensive oversight of content management operations. The category-based filtering approach may enhance content inventory navigation efficiency by reducing interface complexity and enabling content administrators to access relevant content subsets based on categorical criteria that may align with editorial workflows, content management objectives, and organizational structures.

The interface may incorporate a Filter 1040 that may provide interactive category selection mechanisms enabling content administrators to specify which content categories should be displayed within the content inventory interface. A Filter 1040 may implement dropdown menus, checkbox interfaces, or other selection mechanisms that may enable content administrators to choose from available content categories, for example digital content, automotive content, health-related content, home and garden content, lifestyle content, and other categorical classifications that may be relevant for content management operations. The filtering capabilities may support both single-category selection and multiple-category selection approaches, providing flexibility in content inventory views that may accommodate different content management workflows and analytical requirements. In some embodiments, the Filter 1040 may provide category search capabilities that may enable content administrators to locate specific categories within large categorical taxonomies, thereby improving filter usability and enabling efficient category selection processes.

The category-based filtering mechanisms implemented through the Filter 1040 may involve database query operations that may retrieve content items matching specified categorical criteria. The Filter 1040 may maintain filter state information across user sessions, enabling content administrators to return to previously selected categorical views without requiring reconfiguration of filter settings.

The Filter 1040 may perform grouping or clustering of related content items based on a linguistic model to organize content more effectively within categorical structures. The linguistic model may analyze content textual elements, metadata descriptions, and semantic characteristics to identify content relationships that may extend beyond traditional categorical boundaries, thereby enabling more content organization approaches that may capture content similarities and thematic connections. The clustering mechanisms may utilize natural language processing techniques, semantic analysis algorithms, and machine learning models that may identify content patterns and relationships based on linguistic features, topical similarities, and contextual connections between content items. In some embodiments, the linguistic model may generate dynamic content groupings that may evolve based on content analysis results, user engagement patterns, and content performance metrics.

The linguistic model-based clustering approach may complement traditional categorical filtering by providing additional content organization layers that may enable content administrators to identify content relationships that may not be apparent through categorical classification alone. The clustering mechanisms may analyze content titles, descriptions, textual content, and metadata elements to determine semantic similarities and thematic connections between content items, thereby enabling content groupings. The linguistic analysis capabilities may accommodate various content types including textual content, multimedia content descriptions, and metadata elements, providing comprehensive content analysis approaches that may capture diverse content characteristics and relationships within categorical structures.

The category-based filtering interface may provide enhanced content inventory navigation capabilities by enabling content administrators to traverse categorical hierarchies, explore content relationships within categories, and access detailed content information without losing categorical context. The navigation mechanisms may implement breadcrumb displays, category path indicators, and contextual navigation elements that may enable content administrators to understand their current location within categorical structures while providing efficient pathways to related categories and content items. The interface may support bookmark capabilities that may enable content administrators to save frequently accessed categorical views, content item selections, and filter configurations for rapid access during subsequent content management sessions.

In some embodiments, the Filter 1040 may integrate with other interface elements including performance metrics displays, content status indicators, and management control widgets, thereby providing comprehensive content management capabilities within categorical contexts.

Referring now to FIG. 10C, the disclosed subject matter may provide comprehensive interactive content management capabilities through specialized widget mechanisms that enable granular content curation and protection operations within the content inventory management interface. The interactive widget system may address technical challenges associated with providing content administrators with precise control over individual content items while maintaining efficient batch operation capabilities and comprehensive content management workflows.

An Unpublish Widget 1050 may provide interactive content removal capabilities that enable content administrators to designate specific content items as unpublishable through direct interface interaction mechanisms. The Unpublish Widget 1050 may implement visual indicator systems that may display the current publishable status of content items while providing interactive controls that enable content administrators to toggle content availability for serving to end users. The Unpublish Widget 1050 may visually indicate whether the specific content item may be unpublishable through color coding, iconography, or other visual presentation mechanisms that provide immediate status recognition capabilities. The visual indication system may enable content administrators to quickly assess content publishing status across multiple content items.

The Unpublish Widget 1050 interactive capabilities may provide immediate response to user input actions, updating visual indicators and content status information in real-time to reflect content management decisions. In some embodiments, the Unpublish Widget 1050 may provide contextual information displays that may show content performance metrics, expiration status, or other relevant information when content administrators interact with widget elements, thereby supporting informed content management decisions through integrated data presentation mechanisms.

A Protect Widget 1052 may provide content protection capabilities that enable content administrators to shield specific content items from automated unpublishing processes while maintaining editorial control over content lifecycle management decisions. The Protect Widget 1052 may implement protection status visualization mechanisms that may clearly indicate which content items have been designated as protected from automated content management processes. The protect item may visually indicate whether the specific content item may be protected from being designated as unpublishable through distinctive visual markers, status indicators, or color-coded presentation elements that distinguish protected content from unprotected content items within the content inventory display.

The interactive functionality of the Protect Widget 1052 may enable content administrators to modify content protection status through direct widget manipulation. The protection toggle mechanisms may implement logic that may coordinate with automated content management systems to ensure that protection status changes may be properly recognized and enforced across distributed content management components. The interactive protection controls may provide immediate visual feedback when protection status changes occur, updating widget appearance and content status indicators to reflect current protection configurations. In some embodiments, the Protect Widget 1052 may implement protection level controls that may enable content administrators to specify different types of protection policies, such as protection from automated unpublishing, protection from batch operations, protection from specific content management algorithms, protection from manual editing, protection from manual editing by unauthorized users while allowing manual editing by authorized users, coupling of content items where a change in protected status of one item in a group triggers change to all items in the group, protection from permanent change to publishing status but allowing temporary change in status, and the like.

A Flag Widget 1054 may provide content flagging capabilities that enable content administrators to mark content items for review, special attention, or collaborative content management processes within distributed content management workflows. The flagging system may support collaborative content management approaches where multiple content administrators may coordinate content review activities through shared flagging mechanisms that may track content items requiring attention across content management teams and workflows. User interaction with the User Interface may cause a record representative of a content item to be flagged, wherein the flagging process may involve updating content metadata, modifying visual presentation elements, and triggering notification mechanisms that may inform relevant content administrators of flagging actions.

In some embodiments, user interaction with Flag Wiedget my trigger automatic actions, for example an alarm, sending of a notification to specified personal, an automatic editing of the corresponding content item or data associated with the corresponding content item, a change to the display of the corresponding content item, a change to the location within a webpage of the display of the corresponding content item, a change to any aspect of the corresponding content item responsive to the geographical area in which the corresponding content item is displayed, and the like.

The Flag Widget 1054 may implement interactive flagging controls that enable content administrators to toggle flagging status through direct widget interaction while providing immediate visual feedback regarding flagging state changes. In some embodiments, the Flag Widget 1054 may provide input that may enable content administrators to specify resons why content items have been flagged, such as content quality concerns, editorial review requirements, or performance analysis needs, thereby providing contextual information that may support targeted content management actions and collaborative review processes. In some embodiments, the reasons may be displayed, for example at the discretion of the user who input the reason.

The interactive widget system may implement batch operation integration that may enable content administrators to apply widget-based actions to multiple selected content items simultaneously through coordinated batch processing mechanisms. The batch operation capabilities may extend the functionality of individual widgets to support efficient management of content item groups while maintaining the granular control and visual feedback mechanisms provided by individual widget interactions. The batch processing integration may provide confirmation dialogs, operation previews, and rollback capabilities that may ensure batch widget operations may be performed accurately and safely while enabling content administrators to verify batch operation results before final application. The widget-based batch operations may support various content management scenarios including simultaneous content protection assignments, coordinated content flagging operations, and bulk content publishing status modifications that may improve administrative efficiency while maintaining precise control over content management decisions across distributed content management systems.

Referring now to FIG. 11D, the disclosed subject may incorporate a Marked Flag Widget 1154d that may provide visual identification mechanisms for content items that have been designated as requiring attention through user interaction processes. A Marked Flag Widget 1154d may implement distinctive visual presentation elements that may clearly distinguish flagged content items from unflagged content items within the content inventory display, thereby enabling content administrators to quickly identify content items that may require review or special handling. The visual identification mechanisms may utilize color coding, iconography, highlighting effects, or other presentation techniques. The Marked Flag Widget 1154d may maintain flagged status information across user sessions and system operations, ensuring that flagged content items may remain visually distinguished until flagging status may be modified through subsequent user interactions or administrative processes.

The User Interface may highlight flagged content items with distinct background colors for easy visual identification. The background color highlighting mechanisms may implement consistent color schemes that may provide standardized visual indicators across different content categories, content types, and content management contexts. The background color highlighting approach may complement other visual identification mechanisms within the content inventory interface, providing layered visual feedback systems that may enhance content item recognition capabilities through multiple visual cues. The color highlighting may be coordinated with other interface elements including status indicators, performance metrics displays, and interactive control widgets to provide comprehensive visual information systems that may enable content administrators to assess content status, performance characteristics, and management requirements through integrated visual presentation mechanisms.

In some embodiments, the background color highlighting may implement graduated color schemes that may indicate different levels of attention requirements, flagging priorities, or review urgency based on content characteristics, performance metrics, or editorial policies that may influence content management workflows and administrative priorities. In some embodiments, the background color highlighting may be coordinated with other software content management tools, for example an interface to a Recommendation System, an interface to a CMS-agnostic content inventory, an interface to a CMS, and the like, thereby providing a consistent color scheme between interface devices that are part of a distributed computing architecture for managing content items.

In some embodiments, the interface may provide filter or sorting options to view only flagged content items, only unflagged content items, or all content items regardless of flagged status. The filtering capabilities may implement database query mechanisms that may retrieve content items matching specified flagging criteria while maintaining consistent interface presentation formats and interactive functionality across different filtered views.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the

Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
displaying in a user interface a plurality of records representative of a plurality of content items that are publishable on a webpage, wherein each of the plurality of records comprising data descriptive of a corresponding content item;
designating, by a processor, a content item of the plurality of content items as unpublishable, wherein the user interface is updated to reflect the content item being designated as unpublishable; and
preventing from publishing on the webpage the content item due to the unpublishable designation.

2. The method of claim 1, wherein the webpage is published using a Content Management System (CMS) having a content inventory, wherein a content recommendation system comprises a Content Management System (CMS)-agnostic content inventory, wherein the content recommendation system is configured to serve content recommendations based on the CMS-agnostic content inventory, wherein the user interface is a user interface of the content recommendation system, wherein the user interface is configured to assist an administrator of the webpage in curating potential content recommendations to users visiting the webpage.

3. The method of claim 1, wherein said designating is performed automatically and without user intervention.

4. The method of claim 3, wherein a specific content item that is designated as protected cannot be designated automatically as unpublishable.

5. The method of claim 3, wherein said designating is performed at an expiration time of the content item, wherein the expiration time is displayed visually in the user interface.

6. The method of claim 3, wherein the user interface is updated to reflect the content item being designated as unpublishable further comprises: enabling the user interface to display an automatically generated reason for designating the content item as unpublishable.

7. The method of claim 1, wherein said designating is based on a user input that manually designates the content item as unpublishable.

8. The method of claim 1, wherein the user interface comprises a display that includes for each displayed record representative of a specific content item at least the following information:
a title of the specific content item;
a publication time of the specific content item;
a digital media of the specific content item;
a category of the specific content item; and
an expiration time of the specific content item.

9. The method of claim 8, wherein the display further includes for each displayed record representative of a specific content item at least an unpublish icon and a protect icon, wherein the unpublish icon visually indicates whether the specific content item is unpublishable, wherein the unpublish icon is interactive and enables toggling of a published state of the specific content item, wherein the protect icon visually indicates whether the specific content item is protected from being designated as unpublishable, wherein the protect icon is interactive and enables toggling of a protected state of the specific content item.

10. The method of claim 8, wherein the category of a first content item out of the plurality of content items is automatically generated based on information associated with the first content item.

11. The method of claim 8, wherein the user interface enables manual editing of the expiration time of the specific content item.

12. The method of claim 1, wherein user interaction with the user interface causes a record representative of a content item to be flagged, wherein the user interface displays the flagged status when displaying the record representative of a content item.

13. A system comprising:
a processor; and
a memory coupled to the processor and storing instructions that, when executed by the processor, cause the system to:
display in a user interface a plurality of records representative of a plurality of content items that are publishable on a webpage, wherein each of the plurality of records comprising data descriptive of a corresponding content item;
designate a content item of the plurality of content items as unpublishable, wherein the user interface is updated to reflect the content item being designated as unpublishable; and
prevent from publishing on the webpage the content item due to the unpublishable designation.

14. The system of claim 13, further comprising a Content Management System (CMS) and a content recommendation system, said CMS having a content inventory, said content recommendation system comprising a Content Management System (CMS)-agnostic content inventory, wherein the webpage is published using said CMS, wherein said content recommendation system is configured to serve content recommendations based on said CMS-agnostic content inventory, wherein the user interface is a user interface of said content recommendation system, wherein the user interface is configured to assist an administrator of the webpage in curating potential content recommendations to users visiting the webpage.

15. The system of claim 13, wherein said designating is performed automatically and without user intervention.

16. The system of claim 15, wherein a specific content item that is designated as protected cannot be designated automatically as unpublishable.

17. The system of claim 15, wherein said designating is performed at an expiration time of the content item, wherein the expiration time is displayed visually in the user interface.

18. The system of claim 15, wherein the user interface is updated to reflect the content item being designated as unpublishable further comprises: enabling the user interface to display an automatically generated reason for designating the content item as unpublishable.

19. The system of claim 13, wherein said designating is based on a user input that manually designates the content item as unpublishable.

20. The system of claim 13, wherein the user interface comprises a display that includes for each displayed record representative of a specific content item at least the following information:
a title of the specific content item;
a publication time of the specific content item;
a digital media of the specific content item;
a category of the specific content item; and
an expiration time of the specific content item;
wherein the display further includes for each displayed record representative of a specific content item at least an unpublish icon and a protect icon, wherein the unpublish icon visually indicates whether the specific content item is unpublishable, wherein the unpublish icon is interactive and enables toggling of a published state of the specific content item, wherein the protect icon visually indicates whether the specific content item is protected from being designated as unpublishable, wherein the protect icon is interactive and enables toggling of a protected state of the specific content item.
